(19) United States
(12) Patent Application Publication
(10) Pub. No.: US 2018/0116007 A1
(43) Pub. Date: Apr. 26, 2018

(54) COMMUNICATION TERMINAL

(71) Applicant: NTT DOCOMO, INC., Tokyo (JP)

(72) Inventors: Shimpei Yasukawa, Tokyo (JP); Satoshi Nagata, Tokyo (JP); Yongbo Zeng, Beijing (CN); Qun Zhao, Beijing (CN); Yongsheng Zhang, Beijing (CN)

(73) Assignee: NTT DOCOMO, INC., Tokyo (JP)

(21) Appl. No.: 15/564,831

(22) PCT Filed: Apr. 8, 2016
(86) PCT No.: PCT/JP2016/061506

§ 371 Date: Oct. 6, 2017

(30) Foreign Application Priority Data
Apr. 9, 2015 (JP) 2015-080463
May 14, 2015 (JP) 2015-099523

(51) Int. Cl. H04W 76/14; H04W 72/12; H04W 88/04

(52) U.S. Cl. CPC H04W 76/14; H04W 88/04; H04W 72/121; H04W 72/1263

(57) ABSTRACT

According to the present invention, data can be efficiently transmitted to a plurality of remote UEs in a D2D communication. A communication terminal includes a setting section configured to set layer 2 destination information so that identification information included in the destination information separately identifies a plurality of terminals with which D2D is carried out; and an allocating section configured to allocate, in one scheduling interval, the identification information to a control channel in a different subframe per each of the plurality of terminals, and to allocate, in one scheduling interval, transmission data respectively transmitted to the plurality of terminals to a data channel in a different subframe per each of the plurality of terminals.

### TECHNICAL FIELD

The present invention relates to a communication terminal in a next-generation mobile communication system.

### BACKGROUND ART

In LTE (Long Term Evolution) and successor systems to LTE (e.g., LTE-A (LTE Advanced), FRA (Future Radio Access), also known as 4G, etc.), D2D (Device to Device) technology, in which user terminals directly communicate with each other without communicating via a radio base station, are being studied (e.g., Non-Patent Literature 1).

D2Ds are broadly divided in two types: D2D discovery for finding another user terminal with which communication is possible, and D2D communication (also called D2D direction communication) for directly communicating between terminals. Hereinbelow, when D2D communication and D2D discovery, etc., are not particularly referred to, these will be termed as simply “D2D”. Furthermore, signals that are transmitted and received by D2D will be termed “D2D signals”.

A network that semi-statically allocates some of the uplink resources to each user terminal is being studied for use as a D2D signal resource; for example, a user terminal transmitting a discovery signal using an allocated D2D discovery resource. Furthermore, the user terminal can find another user terminal that it can communicate with by receiving, in the D2D discovery resource, a discovery signal transmitted from the other user terminal.

### CITATION LIST

### Non-Patent Literature

Non-Patent Literature 1: “Key drivers for LTE success: Services Evolution”, September 2011, 3GPP, Internet, URL:

<http://www.3gpp.org/ftp/Information/presentations/presentations 2011/2011_09_LTE Asia/2011_LTE-Asia_3GPP_Service evolution.pdf>

### SUMMARY OF INVENTION

### Technical Problem

In regard to the above-mentioned D2D, specifying layer 3 relay devices is studied in Rel. 13. For example, it is conceivable for a user terminal that is within a coverage to carry out D2D with a user terminal that is outside said coverage (hereinafter, “remote UE”), thereby resulting in an expansion of the coverage due to the user terminals functioning as a relay device. Accordingly, an arrangement is needed which can efficiently transmit data from a user terminal to a remote UE.

The present invention has been devised in view of the above discussion, and it is an object of the present invention to provide a communication terminal configured to efficiently transmit data to a plurality of remote UEs in D2D.

### Solution to Problem

According to the present invention, a communication terminal is provided, including a setting section configured to set destination information of a layer 2 so that identification information included in the destination information separately identifies a plurality of terminals with which D2D is carried out; and an allocating section configured to allocate, in one scheduling interval, the identification information to a control channel in a different subframe per each of the plurality of terminals, and to allocate, in the one scheduling interval, transmission data respectively transmitted to the plurality of terminals to a data channel in a different subframe per each of the plurality of terminals.

Technical Advantageous of Invention

According to the present invention, data can be efficiently transmitted to a plurality of remote UEs in D2D.

### BRIEF DESCRIPTION OF DRAWINGS

FIG. 1 illustrates diagrams of a radio resource configuration in D2D communication.

FIG. 2 is a diagram illustrating an example of a PSCCH resource bitmap.

FIG. 3 is a schematic configuration diagram illustrating an example of a schematic configuration of a radio communication system.

FIG. 4 is an explanatory diagram of a process of generating a destination ID and transmission data for different remote terminal destinations in D2D.

FIG. 5 illustrates explanatory diagrams of an example of data transmission for different remote terminal destinations being transmitted at different PSCCH periods (1 scheduling interval).

FIG. 6 is a schematic configuration diagram illustrating an example of a schematic configuration of a radio communication system of an embodiment of the present invention.

FIG. 7 illustrates explanatory diagrams of SCI transmission in the embodiment of the present invention.

FIG. 8 is an explanatory diagram of a process of generating a destination ID and transmission data for different remote terminal destinations according to aspect 1 of the embodiment of the present invention.

FIG. 9 is an explanatory diagram of data transmission, according to the aspect 1 of the embodiment of the present invention.

FIG. 10 is an explanatory diagram of a process of generating a destination ID and transmission data for different remote terminal destinations according to aspect 2 of the embodiment of the present invention.

FIG. 11 is an explanatory diagram of data transmission, according to aspect 2 of the embodiment of the present invention.

FIG. 12 is an explanatory diagram of processes between components of the radio communication system, according to aspect 2 of the embodiment of the present invention.

FIG. 13 is an explanatory diagram of a process of generating a destination ID and transmission data for different remote terminal destinations according to aspect 3 of the embodiment of the present invention.

FIG. 14 is an explanatory diagram of data transmission, according to aspect 3 of the embodiment of the present invention.

FIG. 15 is an illustrative diagram of a schematic configuration of a radio communication system of according to the illustrated embodiment of the present invention.

FIG. 16 is an illustrative diagram of an overall configuration of a radio base station according to the embodiment of the present invention.

FIG. 17 is an illustrative diagram of an overall configuration of a user terminal according to the embodiment of the present invention.

FIG. 18 is an illustrative diagram of a functional configuration of the user terminal (relay device) according to the embodiment of the present invention.

FIG. 19 is an illustrative diagram of a functional configuration of the user terminal (remote UE) according to the embodiment of the present invention.

FIG. 20 is an explanatory diagram of an overwriting of a sidelink grant, according to aspect 1 of the embodiment of the present invention.

FIG. 21 is an explanatory diagram of configuration of a plurality of sidelink grants, according to aspect 1-1 of the embodiment of the present invention.

FIG. 22 is an explanatory diagram of configuration of a plurality of sidelink grants, according to aspect 1-2 of the embodiment of the present invention.

FIG. 23 is an explanatory diagram of configuration of a plurality of sidelink grants, according to aspect 1-3 of the embodiment of the present invention.

FIG. 24 is an explanatory diagram of an L2 destination ID conflict, according to aspect 3 of the embodiment of the present invention.

FIG. 25 is an explanatory diagram of a MAC header, according to aspect 3-1 of the embodiment of the present invention.

FIG. 26 is an explanatory diagram of a change in an L2 destination ID, according to aspects 3-2 and 3-3 of the embodiment of the present invention.

### DESCRIPTION OF EMBODIMENTS

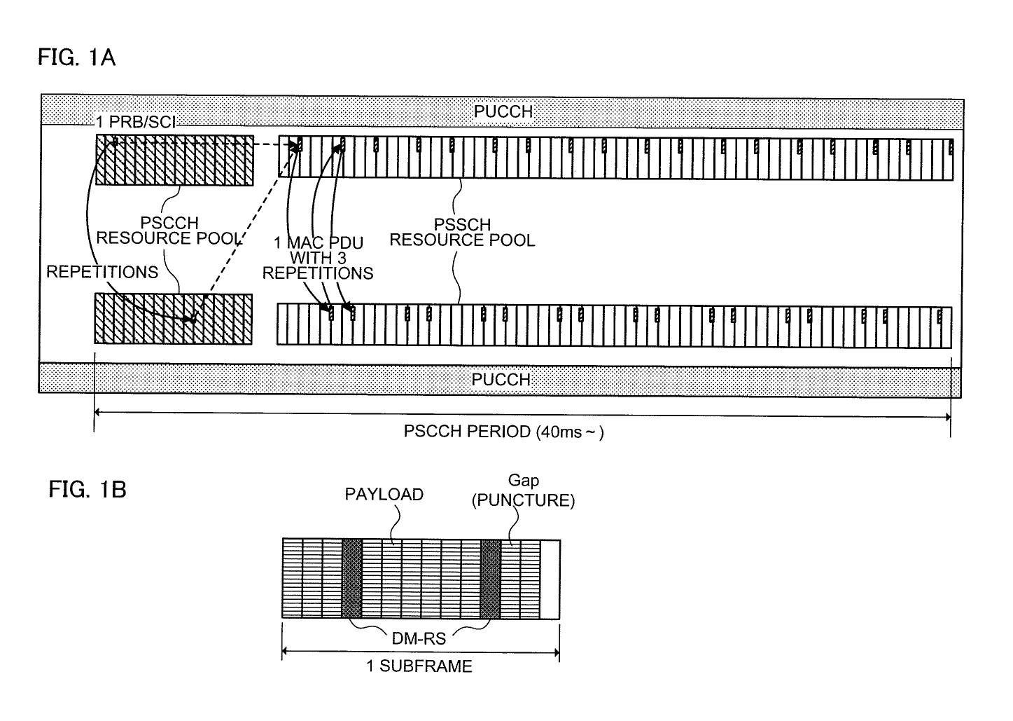

First of all, an explanation in regard to D2D supported in Rel. 12 will be discussed hereinbelow. FIG. 1A illustrates a radio resource configuration transmitted by D2D communication, in D2D supported in Rel. 12. The vertical axis indicates the frequency, and the horizontal axis indicates time. In D2D communication, control information and data transmitted in one scheduling corresponds to one period (one scheduling interval), and is called a “PSCCH (Physical Sidelink Control Channel) period” or a “communication period”. The PSCCH period has, e.g., a length of 40 ms or more.

In D2D, since an UL resource is used, a PUCCH (Physical Uplink Control Channel) is located at the frequency end of the transmitted radio resource. A PSCCH resource pool (SA pool) and a PSSCH (Physical Sidelink Shared Channel) resource pool (data pool) are provided along the time axis at locations toward the center frequency, relative to the PUCCH. These resource pools are, for example, provided in advance via a broadcast (written in a SIB (System Information Block), etc.). Note that in regard to the PSSCH resource pool, the PSSCH resource pool is notified for resource allocation of Mode 2 that is defined in Rel. 12 (in which the user terminal randomly decides on the transmission resources), and in Mode 1 (in which resources are allocated by the radio base station) all of the uplink resources are shared in the PSSCH.

In the PSCCH, control information in regard to data transmitted in the PSSCH is allocated in the PSCCH. The control information has a fixed resource size of 1 PRB (Physical Resource Block) pair, and in the case where QPSK (Quadrature Phase Shift Keying) is applied, an MCS (Modulation and Coding Scheme) index may be designated. Furthermore, when a radio resource is allocated to the control information in the PSCCH, one repetition of frequency hopping may be carried out, as illustrated in FIG. 1.

The PSSCH is used in transmission of MAC (Media Access Control) PDU (Packet Date Unit) data. When a radio resource is allocated to data on the PSCCH, three repetitions of frequency hopping may be carried out, as illustrated in FIG. 1. The PSSCH, similar with the PUSCH, can be used by semi-static allocation.

In such a D2D radio resource configuration, one PSCCH scheduling is used (a plurality of MAC PDUs are scheduled) to continuously transmit, e.g., audio data, etc., in the PSSCH. FIG. 1B illustrates a PUSCH base for the PSCCH and PSSCH.

An SCI (Sidelink Control Information) format 0, of the control information transmitted in the D2D control channel (PSCCH), includes a frequency hopping flag (1 bit), resource block allocation and hopping resource allocation (log 2(N^{SL}_{RB}(N^{SL}_{RB}+1)/2) bits), a time resource pattern (7 bits), an MCS (5 bits), a TA (11 bits), and a group destination ID (8 bits).

The frequency hopping flag, the resource block allocation and hopping resource allocation are all pre-existing. Hopping similar to PUSCH hopping can be applied to the PSSCH. Furthermore, type 1 PUSCH hopping and type 2 PUSCH hopping are supported.

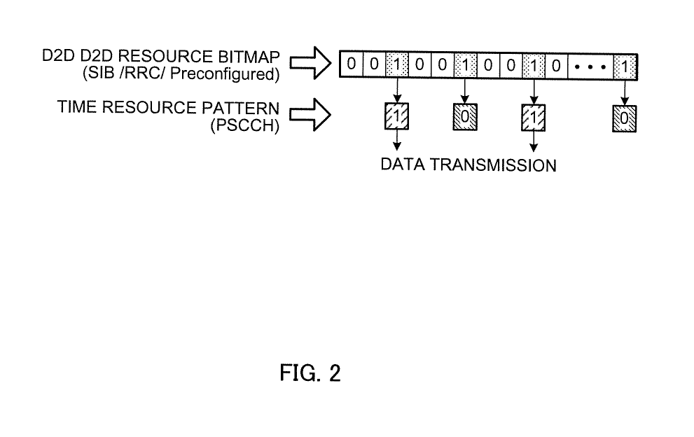

The time resource pattern is bitmap information; for example, information indicated with 0s and 1s that indicate whether or not signals are transmitted in a specified subframe, as illustrated in FIG. 2. In D2D, since the same uplink resource is normally used, there are limitations in the transmission and reception. Accordingly, it is necessary to define the transmission and reception per each subframe.

The MCS uses 5 bits and 64QAM (Quadrature Amplitude Modulation) is not applied thereto; TA (Time Adjustment) is used for the time adjustment of the PSSCH reception.

The group destination ID in D2D fundamentally has a broadcast base design, and communication terminals that carry out D2D receive all signals that arrive thereat. Accordingly, in D2D, if a large number of communication terminals carry out data transmission, faster battery consumption occurs in the communication terminals at the receiving end.

As mentioned above, in D2D in Rel. 13, the specifying of layer 3 relays is studied, in which it is conceivable for a communication terminal (user terminal) within coverage to carry out D2D communication with a remote UE, and to function as a relay device by relaying data from a radio base station. Hence, the coverage of the radio base station can be expanded.

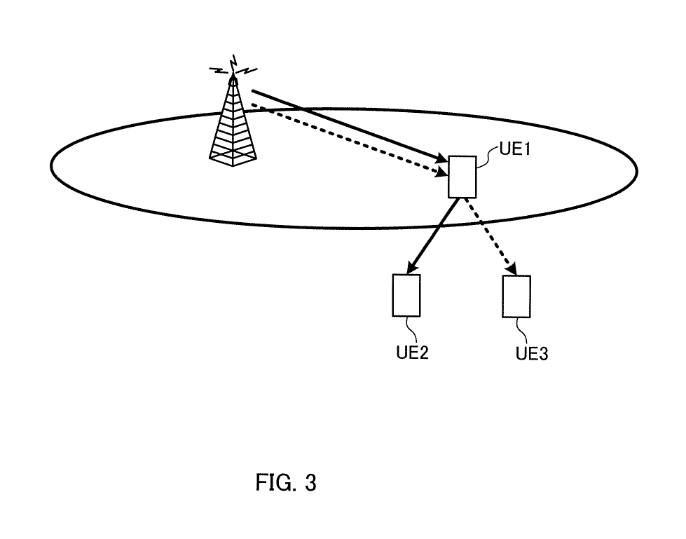

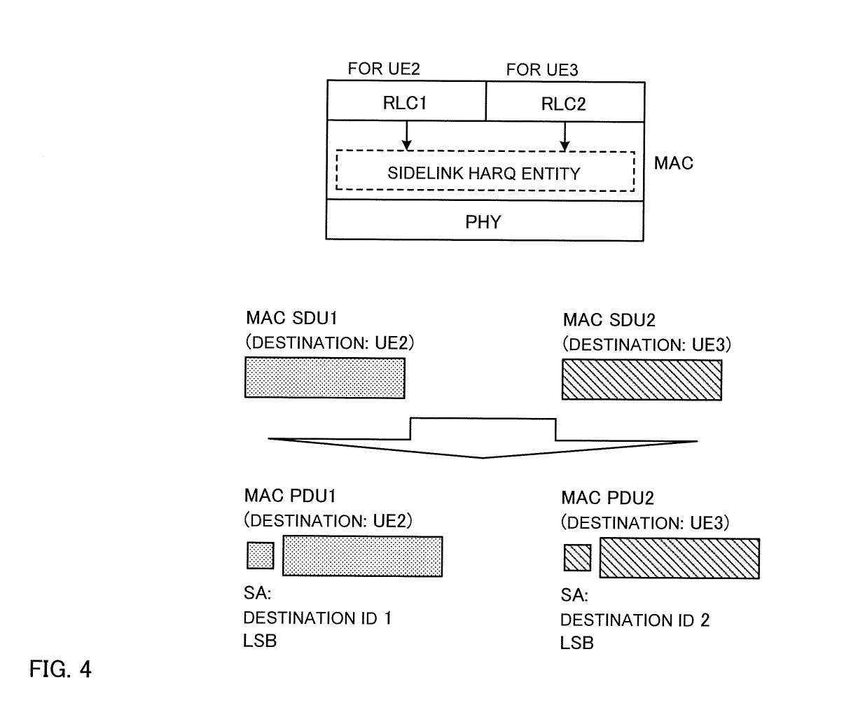

For example, in a radio communication system illustrated in FIG. 3, a case is assumed in which a user terminal UE1 functions as a relay device to relay different data sent from the radio base station to a remote UE2 and a remote UE3, respectively, which are located outside the coverage of the radio base station. In this case, as illustrated in FIG. 4, the user terminal UE1 generates a MAC PDU1 for the remote UE2 and a MAC PDU2 for the remote UE3. Furthermore, the user terminal UE1 generates a destination ID1 that specifies the remote UE2, and generates a destination ID2 that specifies the remote UE3. LSB (Least Significant Bit) 8 bits in the destination ID of layer 2 of the remote UE2 are applied to the destination ID1. In addition, LSB (Least Significant Bit) 8 bits in the destination ID of layer 2 of the remote UE3 are applied to the destination ID2.

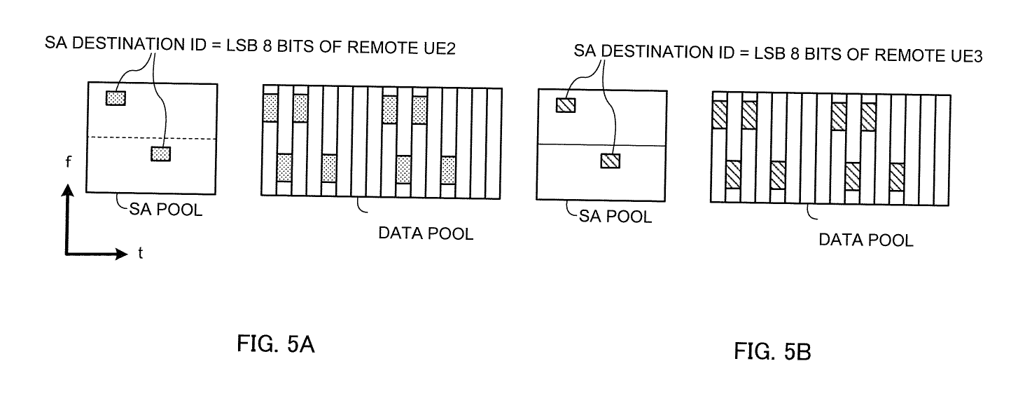

Thereafter, the user terminal UE1 performs a process to allocate the generated destination and data to a radio resource. However, as mentioned above, in D2D, only one data transmission can be sent to one remote UE (or one destination group) in one PSCCH period. Therefore, as illustrated in FIG. 5A and FIG. 5B, radio resources are allocated for the destination ID and transmission data in order for the data transmission to the remote UE2 and data transmission to the remote UE3 to be carried out at different PSCCH periods.

In other words, after transmission of data addressed to one of the remote UE2 and the remote UE3 is carried out in a first PSCCH period, transmission of data addressed to the other of the remote UE2 and the remote UE3 is carried out in a second PSCCH period. Accordingly, it is conceivable that a delay may occur in the receiving of data in each remote UE. In particular, if the transmission data is audio data, such a delay would deteriorate usability.

Furthermore, in regard to the expansion of coverage, although it is desirable for the communication terminal that functions as a relay device to communicate with a large number of remote UEs, the increase in delay of data transmission is proportional to the increase in the number of remote UEs that are accessed.

The inventors of the present invention arrived at the present invention by focusing on the group destination ID in layer 1 through layer 3, and also focusing on the fact that the remote UEs can be separately specified (identified) in the destination IDs in at least layer 3.

(Common Structure and Summary of Embodiments 1 Through 3)

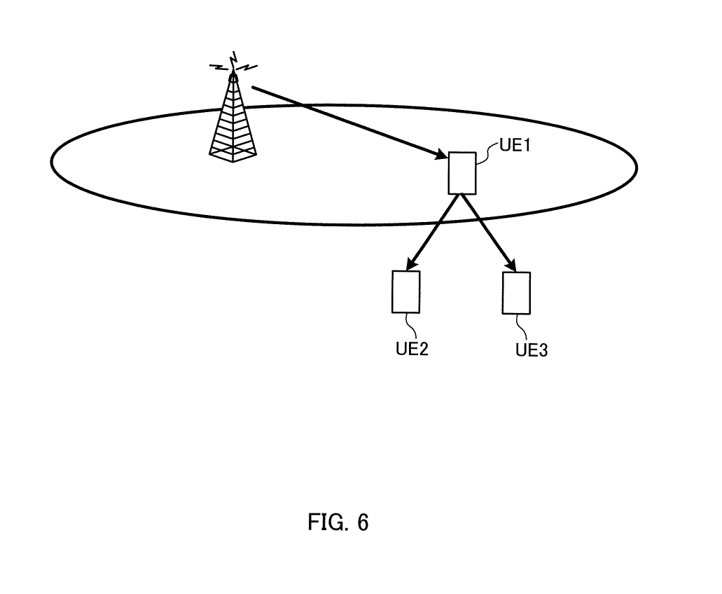

FIG. 6 illustrates a schematic configuration of a radio communication system of the embodiments of the present invention. The communication terminal UE1 is a user terminal that supports D2D (in which D2D discovery and D2D communication is possible), and is located within the coverage of a radio base station. Furthermore, the remote UE2 and the remote UE3 are user terminals that support D2D and are located outside the above-mentioned coverage.

The communication terminal UE1 carries out D2D based communication with the remote UE2 and the remote UE3. Furthermore, the communication terminal UE1 functions as a so-called “relay device” by transmitting data, which is transmitted from the radio base station, to the remote UE2 and the remote UE3, which are outside the coverage. Note that the communication terminal UE1 may be a user-portable communication terminal or a fixed terminal that is located within the coverage of the radio base station. In the embodiments of the present invention, the communication terminal UE1 transmits different data addressed to the remote UE2 and the remote UE3 in a single PSCCH period.

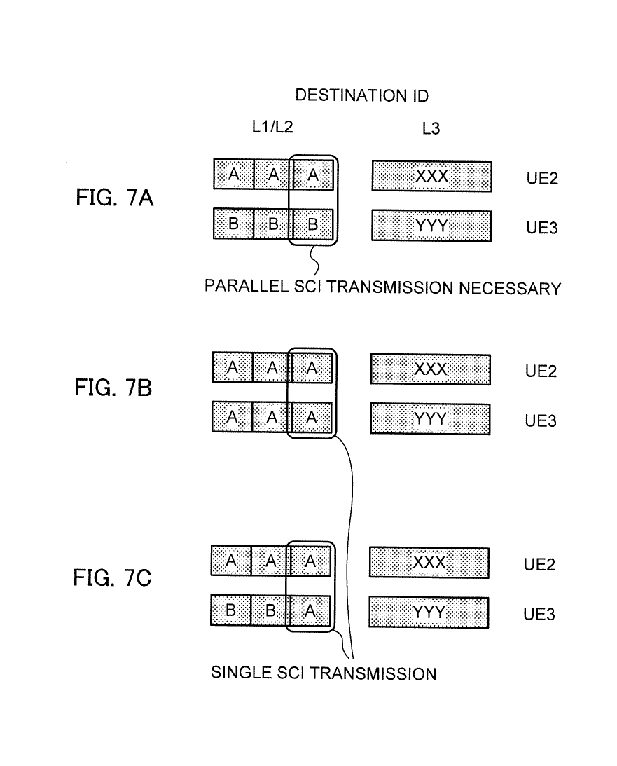

Although each aspect of the present embodiment will be discussed below, in aspect 1, the destination IDs of layer 1 (L1), layer 2 (L2) and layer 3 (L3) are set differently for the remote UE2 and the remote UE3, as illustrated in FIG. 7A. In aspect 2, the same L2 group ID is set for each remote UE, as illustrated in FIG. 7B. In aspect 3, the LSB 8 bits of the L2 destination ID are set the same for each remote UE, as illustrated in FIG. 7C.

However, in aspect 1, although the remote UE2 is AAA and the remote UE3 is BBB, not all of the bits need to be different from each other so long as AAA and BBB are different in combination. For example, it is acceptable for 1 bit of L2 to be different. In aspect 2, L2 is the same between the remote UEs. In aspect 3, although a group can always be received in the physical layer (L1), it is necessary for the ID of the L2 to be different for each remote UE. Accordingly, the last 8 bits are common for each remote UE, and at least 1 bit of the remaining bits (24-8=16 bits) is different for each UE.

(Aspect 1)

Aspect 1 will be hereinafter described with reference to FIGS. 7A, 8 and 9.

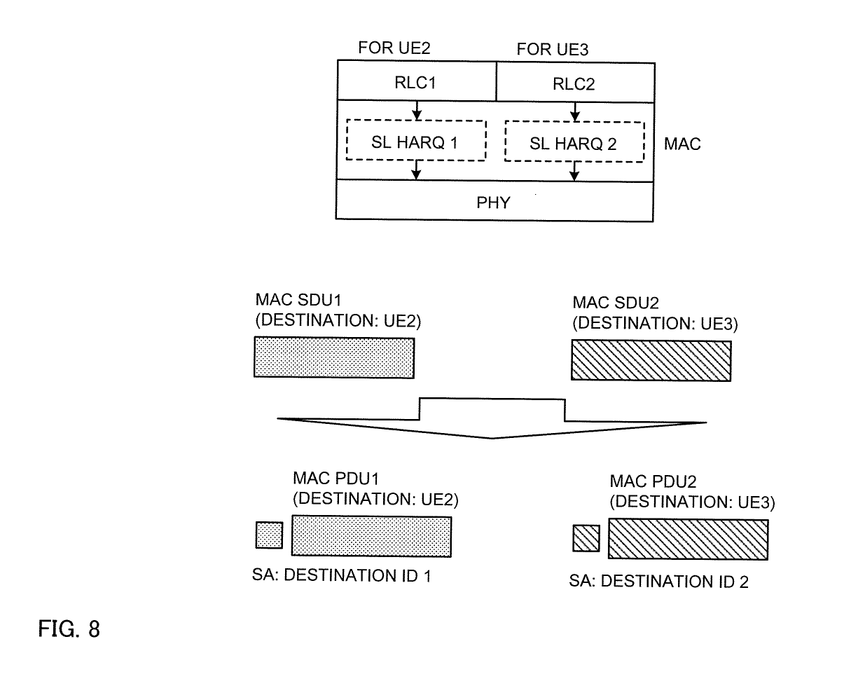

As mentioned above, in aspect 1, the destination IDs of L1, L2 and L3 are set differently for the remote UE2 and the remote UE3 (FIG. 7A). Hence, the communication terminal UE1 provides a HARQ entity for transmitting transmission data (a plurality of MAC PDUs) for each of the remote UE2 and the remote UE3 (FIG. 8). Furthermore, the scheduling between the different HARQ entities (e.g., a PSCCH resource and a data T-RPT (Time-Resource Pattern) selection) can be carried out independently or dependently.

As illustrated in FIG. 8, in the communication terminal UE1, different HARQ entities/processes, SL HARQ1 and SL HARQ2, are configured in the MAC layer. SL HARQ1 adds a MAC header to an RLC (Radio Link Control) PDU (Packet Data Unit) (MAC (Media Access) SDU (Service Data Unit) 1) addressed to the remote UE2 and generates a MAC PDU1. On the other hand, SL HARQ2 adds a MAC header to an RLC PDU (MAC SDU2) addressed to the remote UE3 and generates a MAC PDU2.

The communication terminal UE1 generates a destination ID1 that identifies the remote UE2, and a destination ID2 that identifies the remote UE3. LSB 8 bits in the layer 2 destination ID of the remote UE2 are applied to the destination ID1 of the PSCCH. LSB 8 bits in the layer 2 destination ID of the remote UE3 are applied to the destination ID2 of the PSCCH.

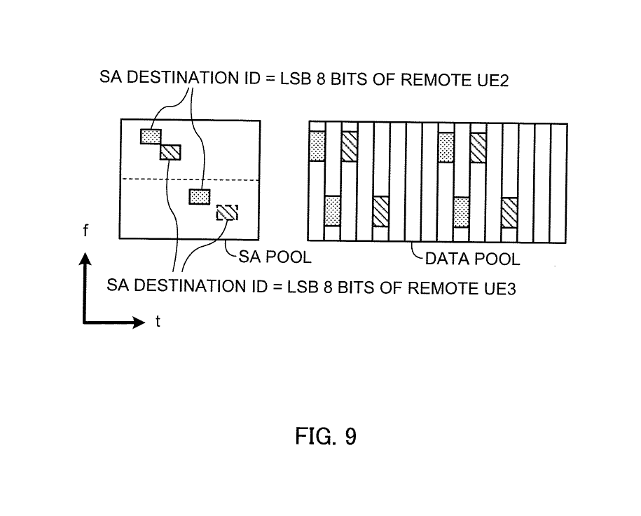

The communication terminal UE1 allocates the generated destination ID1 and the destination ID2 in the PSCCH resource pool. For example, as illustrated in FIG. 9, resources of different subframes are respectively allocated to the destination ID1 and the destination ID2 so that the destination ID1 and the destination ID2 do not overlap each other along the time axis. Even in the case where frequency hopping is carried out, as illustrated in FIG. 9, resources of different subframes are respectively allocated to a frequency hopping destination ID1 and a frequency hopping destination ID2.

The communication terminal UE1 allocates the generated MAC PDU1 and MAC PDU2 to the PSSCH resource pool. For example, as illustrated in FIG. 9, resources of different subframes are respectively allocated to MAC PDU1 and MAC PDU2 so that MAC PDU1 and MAC PDU2 do not overlap each other along the time axis. Even in the case where frequency hopping is carried out, as illustrated in FIG. 9, resources of different subframes are respectively allocated to MAC PDU1 and MAC PDU2.

Due to the above-described resource allocation being carried out, different data can be transmitted to a plurality of remote UEs in a single PSCCH period; in other words, data can be transmitted in parallel.

Note that the above described D2D is, fundamentally, in a single carrier due to the uplink being used. Furthermore, the L2 group ID can be categorized into three types: “unicast ID”, “group cast ID” and “broadcast ID”; the ID that is transmitted in aspect 1 is a unicast ID. The unicast L2 ID is first used as a destination ID using 8 bits out of the SCI (Sidelink Control Information), and thereafter a bit array of the remainder of the unicast ID out of the MAC header, of the MAC PDU, is entered.

In aspect 1, a sidelink HARQ entity is divided per remote UE2 and UE3, and a plurality of HARQ entities corresponding to different destinations exist in the communication terminal UE1. A plurality of MAC PDUs that are associated with a single PSCCH (SCI) are sent to the same communication terminal UE1. A plurality of PSCCHs (SCIs) and their corresponding data may be transmitted in a single PSCCH period.

In the case where transmission of PSCCHs or data to different remote UEs occur in the same subframe (occurrence of a plurality of transmissions), if the function of the remote UE at the receiving end is compatible, the communication terminal UE1 may carry out a plurality of transmissions (discontinuous allocation) according to aspect 1. Alternatively, the communication terminal UE may select a signal transmission and dispose of the remaining transmissions.

The above-described PSCCH (SCI) and data resource selection by different HARQ entities/processes may be independently carried out. However, if a resource collision or frequency segmentation occurs, transmission may be randomly disposed.

Furthermore, if the PSCCH (SCI) and data resource selection are carried out in association with each other, the PSCCH (SCI) resource index for each PSCCH may be randomly selected from all of the indexes. Accordingly, frequency segmentation does not occur in any of the PSCCH (SCI) transmissions. Alternatively, the data T-RPT indexes may be selected from various patterns. In such a case, frequency segmentation does not occur in any of the transmissions of D2D data.

A method similar to the scheduling in a radio base station for different user terminals (e.g., round robin or PF) may be applied to scheduling for different HARQ entities/processes (between remote UEs).

In aspect 1, in the case where D2D resource allocation (mode 1 resource allocation) is carried out from the radio base station, it is necessary to carry out resource allocation by transmitting a plurality of DCIs (Downlink Control Information) to one communication terminal. When this is carried out, since a plurality of DCIs are transmitted in a PDCCH or EPDCCH using the same DCI format, the terminal tries to detect in every search space even in the case where the terminal has detected an appropriate DCI format.

(Aspect 1-1)

As described above, in D2D mode 1 resource allocation, a plurality of DCIs are transmitted to one communication terminal. However, as described above, since only one DCI can be transmitted in one PSCCH period (or SC (Sidelink Control) period), this results in only one sidelink grant being transmitted. This sidelink grant can be used to identify a subframe set to be used in SCI and data transmission. Note that since the SC interval has a predetermined length that repeats sequentially, the SC interval may be called the “SC period”.

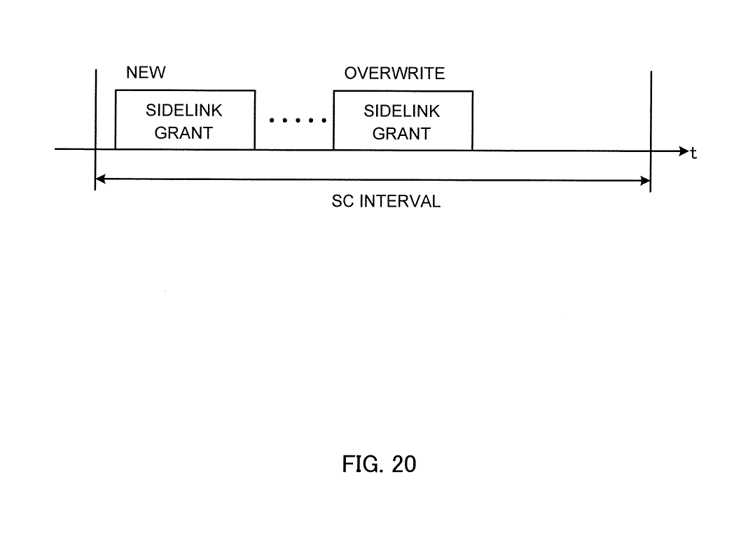

Since the SC period has, e.g., a length of 40 ms or more, a plurality of subframes are included therein. Therefore, although it is conceivable for sidelink grants to be transmitted in a number of subframes (e.g., a sidelink grant destination to a user terminal that is identified by the radio base station), sidelink grants that are sent after a predetermined subframe (e.g., from 4 subframes onwards) are overwritten by the previous sidelink grant (see FIG. 20).

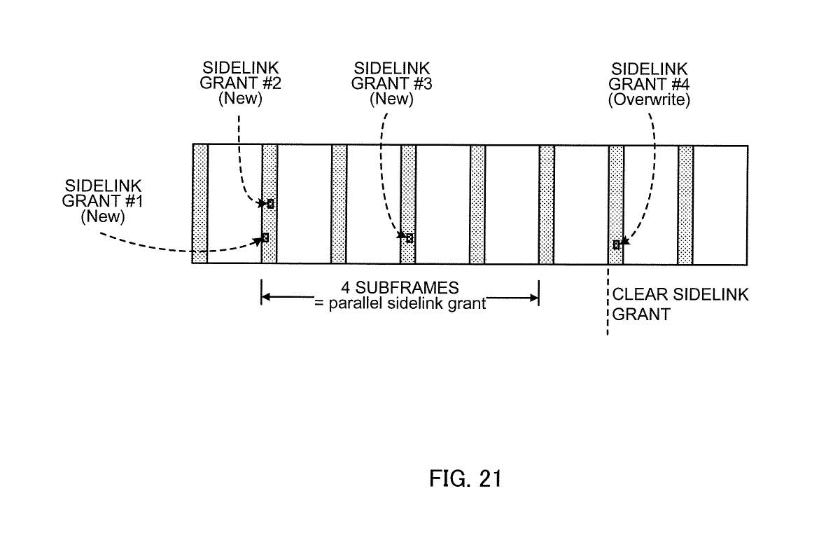

In aspect 1-1, a plurality of sidelink grants can be set in a user terminal that functions as a D2D communication terminal. For example, as illustrated in FIG. 21, the user terminal is configured so that a plurality of sidelink grants can be set, providing they are set within a predetermined number of subframes (e.g., four subframes). Specifically, in FIG. 21, sidelink grants #1 through #3 that are transmitted within four subframes can be set in the user terminal.

However, in the case where, upon a plurality of sidelink grants being set, a sidelink grant is received after the predetermined number of subframes, the user terminal cannot determine which sidelink grant of the previously set sidelink grants to overwrite with the newly transmitted sidelink grant. For example, in FIG. 21, when the user terminal receives a sidelink grant #4, the user terminal cannot determine which out of the previously set sidelink grants #1 through #3 to overwrite using sidelink grant #4.

Therefore, in the case where the user terminal receives a sidelink grant at a subframe from the predetermined subframe number onwards, the user terminal is configured to clear (delete) the previously set sidelink grants and set the newly-received sidelink grant. Specifically, in FIG. 21, if sidelink grant #4 is transmitted after four subframes, the user terminal clears sidelink grants #1 through #3 and newly sets sidelink grant #4.

Hence, according to aspect 1-1, it is possible to set a plurality of sidelink grants even if an existing DCI is used, and data can be efficiently transmitted in D2D to a plurality of remote UEs. In other words, in one SC interval, a plurality of SCIs can be transmitted with respect to different group IDs (identification information). Note that, as described above, aspect 1-1 can be applied to a D2D user terminal. Accordingly, aspect 1-1 can be similarly applied also in the case where a relay process is performed between D2D user terminals.

(Aspect 1-2)

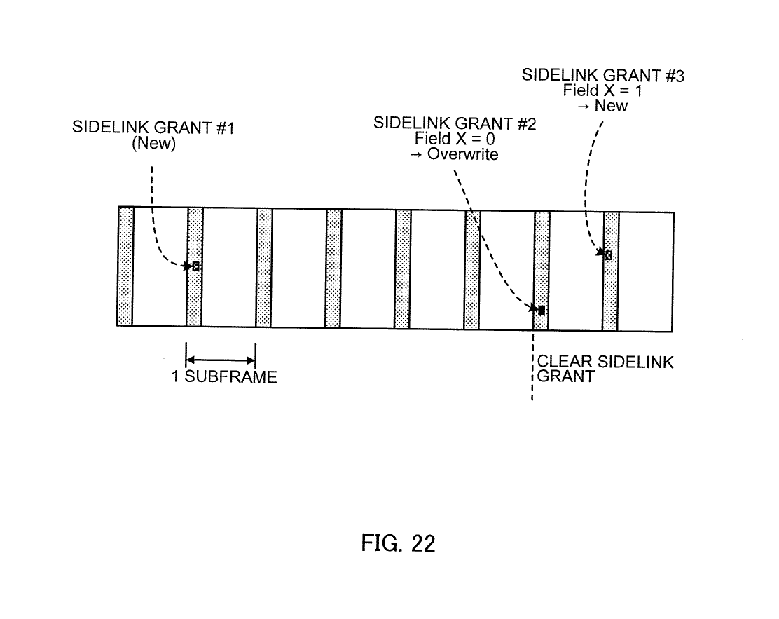

Next aspect 1-2 will be discussed with reference FIG. 22. Aspect 1-2 is a configuration which explicitly instructs the D2D user terminal as to whether or not a sidelink grant needs to be overwritten (explicitly maps a sidelink grant number (index)). In regard to mapping, a bit field not used by the DCI format (identified bit field) is used, and a sidelink grant index (or overwrite, or a new sidelink grant) is identified.

Part of an existing bit field of a frequency hopping flag, etc., or a bit field that has not been used due to zero padding may be used as a designated bit field. For example, DCI format 5 is zero padded since DCI format 5 is set to the same payload length as that of DCI format 0. This zero padded bit field can be used.

However, in the case where a bit field that is normally used for a frequency hopping flag, etc., is used, the user terminal may be notify (may be semi-statically configured) in advance via higher layer signaling, such as RRC, etc., that this bit field is to be used to identify a sidelink grant index (or overwrite, or a new sidelink grant).

In FIG. 22, after sidelink grant #1 is set, sidelink grants #2 and #3 are transmitted sequentially. At this time, since a “0” that indicates an overwrite is set at a identified bit field (Field X) of the designated bit fields, the user terminal overwrites sidelink grant #2 onto sidelink grant #1.

Whereas, in regard to sidelink grant #3 which is transmitted after sidelink grant #2, since “1” that indicates a new sidelink grant is written in the identified bit field, the user terminal newly sets the sidelink grant #3.

Hence, according to aspect 1-2, it is possible to set a plurality of sidelink grants even if an existing DCI is used, and data can be efficiently transmitted in D2D to a plurality of remote UEs. In other words, in one SC interval, a plurality of SCIs can be transmitted with respect to different group IDs. Note that, as described above, aspect 1-2 can be applied to a D2D user terminal. Accordingly, aspect 1-2 can be similarly applied also in the case where a relay process is performed between D2D user terminals.

(Aspect 1-3)

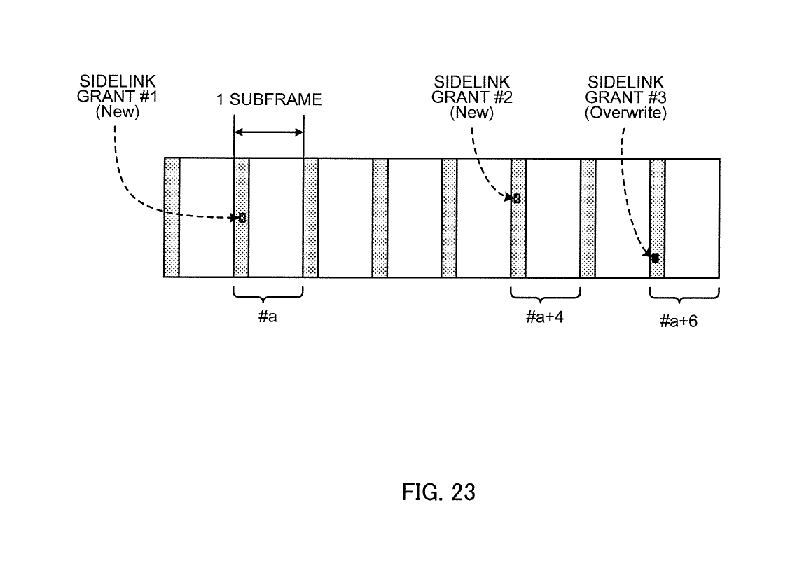

Next aspect 1-3 will be discussed with reference FIG. 23. Aspect 1-3 is a configuration in which an existing DCI format is used, search spaces are divided, and information (e.g., destination indexes or sidelink grant indexes) identifying sidelink grants are mapped in advance. Since a plurality of search space candidates are included within a PSCCH period, one of these search spaces is time/frequency divided and used for the above-mentioned mapping.

In the division of the search spaces, an RNTI or a time-frequency resource can be used. A sub search space that is generated by the above-mentioned division is mapped to a destination index or a sidelink grant index, as mentioned above. The mapping is notified via higher layer signaling such as RRC signaling, etc.

In FIG. 23, sidelink grant #1 is transmitted in subframe #a, and thereafter sidelink grant #2 is transmitted in subframe #a+4, which is four subframes later. Thereafter, sidelink grant #1 is transmitted in subframe #a+6, which is a further two subframes later. Since the user terminal can identify sidelink grants #1 and #2 from the sub search spaces, in subframe #a+6, the user terminal overwrites the received sidelink grant #1 onto the sidelink grant #1 that was set in subframe #a.

Hence, according to aspect 1-3, it is possible to set a plurality of sidelink grants even if an existing DCI is used, and data can be efficiently transmitted in D2D to a plurality of remote UEs. In other words, in one SC interval, a plurality of SCIs can be transmitted with respect to different group IDs. Note that, as described above, aspect 1-3 can be applied to a D2D user terminal. Accordingly, aspect 1-3 can be similarly applied also in the case where a relay process is performed between D2D user terminals.

Furthermore, in each of aspects 1-1 through 1-3, an existing DCI format is used. However, for example, a new DCI format may be set that is combined with information that identifies sidelink grants (e.g., destination indexes or sidelink grant indexes).

(Aspect 2)

Aspect 2 will be hereinafter described with reference to FIGS. 7B, 10 and 11.

As mentioned above, in aspect 2, the same L2 group ID is set for each remote UE, as illustrated in FIG. 7B. In other words, the same L2 group ID is set for all of the remote UEs that receive data relayed from the communication terminal UE1. This kind of group ID may be used to implement group ID notification to remote UEs by including the group ID in a signal/notification used in D2D discovery (a signal/notification from a user terminal within coverage to a user terminal outside coverage).

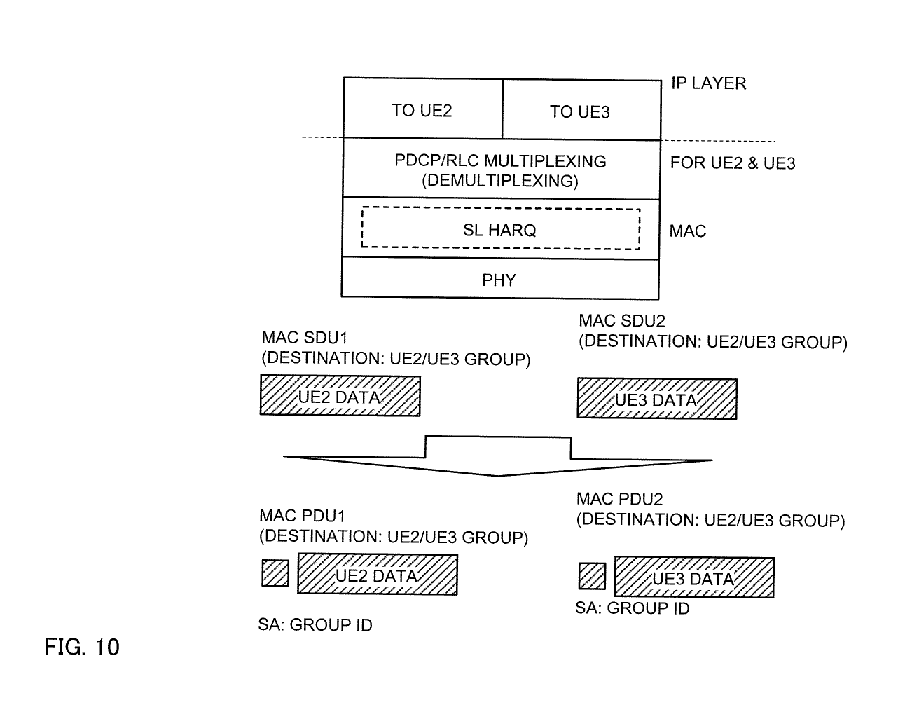

The MAC layer of the communication terminal UE1 cannot determine whether or not the transmission data (downlink data) is addressed to any of the remote UEs. However, in the higher layer (RLC/PDCP/IP), data for different remote UEs can be multiplexed (demultiplexed) (FIG. 10).

Furthermore, as illustrated in FIG. 10, an SL HARQ is configured in the MAC layer of the communication terminal UE1. This SL HARQ adds a MAC header to an RLC PDU (MAC SDU1) addressed to the remote UE2 and generates a MAC PDU1. On the other hand, SL HARQ2 adds a MAC header to an RLC PDU (MAC SDU2) addressed to the remote UE3 and generates a MAC PDU2. The communication terminal UE1 generates a group ID that identifies the remote UE2/UE3.

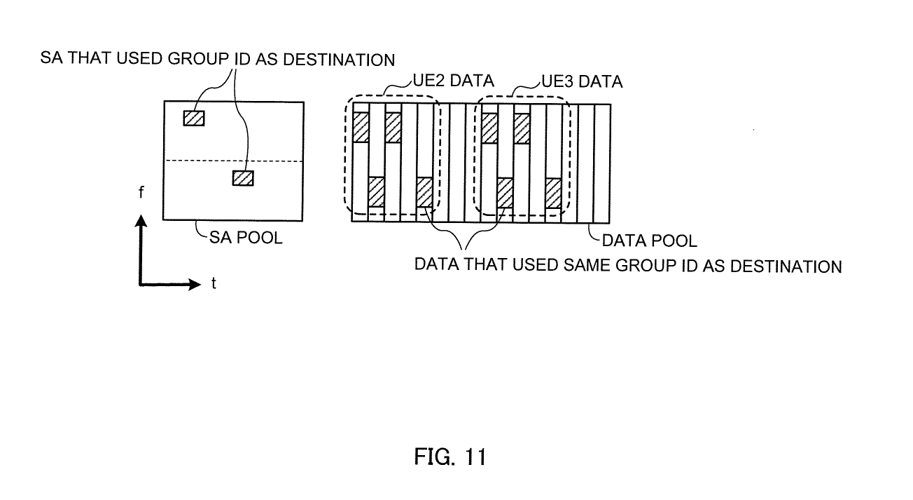

The communication terminal UE1 allocates the set or generated group ID to the PSCCH resource pool (FIG. 11). In the PSCCH resource pool illustrated in FIG. 11, frequency hopping is carried out. Furthermore, the communication terminal UE1 allocates the generated MAC PDU1 and MAC PDU2 to the PSSCH resource pool. For example, as illustrated in FIG. 11, resources of different subframes are respectively allocated to MAC PDU1 and MAC PDU2 so that MAC PDU1 and MAC PDU2 do not overlap each other along the time axis. Even in the case where frequency hopping is carried out, as illustrated in FIG. 11, resources of different subframes are respectively allocated to MAC PDU1 and MAC PDU2.

Due to the above-described resource allocation being carried out, data can be transmitted to a plurality of remote UEs in a single PSCCH period. Since the transmission data for the remote UE2 cannot be distinguished from the transmission data for the remote UE3 in the MAC layer of the communication terminal 1, the same hatching is used in FIGS. 10 and 11. However, since the L3 destination ID is different for each remote UE, each remote UE can determine whether or not the transmission data is addressed to itself by using the L3 destination ID.

Furthermore, in aspect 2, all of the remote UEs that perform D2D with the communication terminal UE1 receive data using the same group destination L2 ID. In this case, the group destination L2 ID may include an announcement from the relay UE before the communication terminal UE1 (relay device) is selected. Alternatively, after the communication terminal (relay device) has been selected by the remote UE, the group destination L2 ID may also be notified using a remote UE destination signal from the communication terminal. Furthermore, in the case where a plurality of different communication terminals are used as relay devices, the destination L2 ID may be set differently for each communication terminal.

In aspect 2, in the physical layer (PHY) and MAC layer, all of the transmission data (downlink data) addressed to all of the remote UEs is received at each remote UE. Multiplexing/demultiplexing of data addressed to different remote UEs may be controlled at a higher layer such as a PDCP/RLC/IP layer, etc.

The group destination L2 ID used in the DL reception in the remote UEs is transmitted from the communication terminal UE1 (relay device) to the remote UEs. Each remote UE uses the same group destination L2 ID to receive DL data.

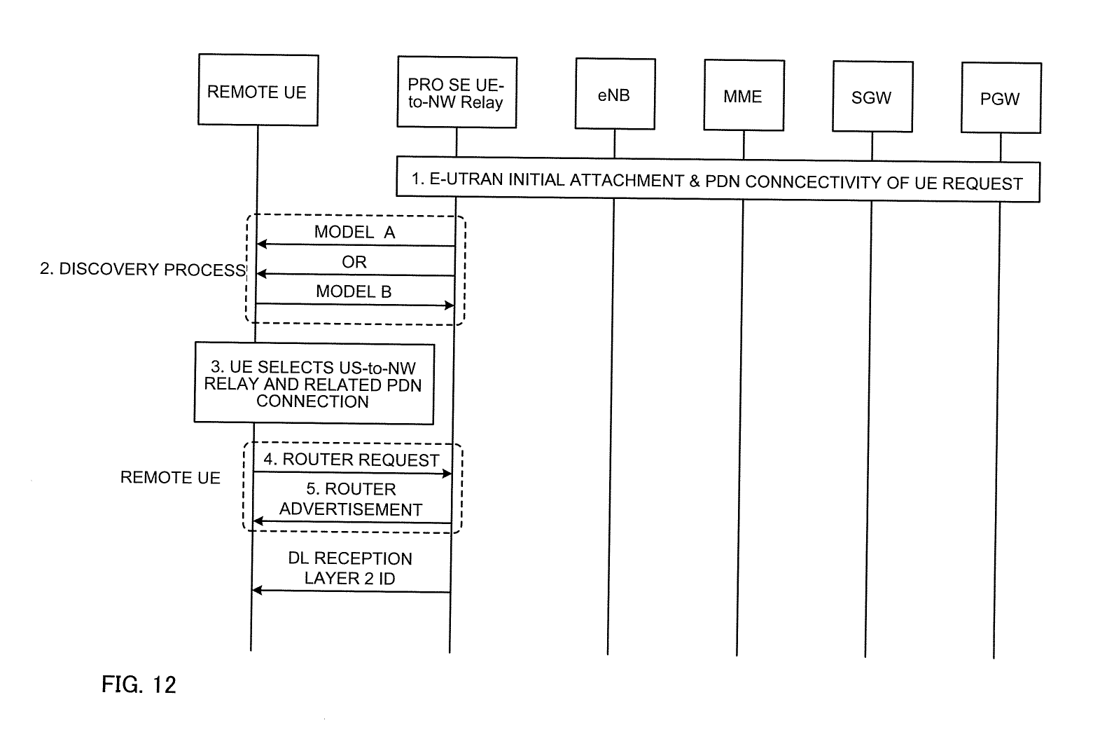

Hereinbelow a communication flow for carrying out a relaying process using D2D (DL reception in the remote UE) will be described with reference to FIG. 12.

As illustrated in FIG. 12, an E-UTRAN initial attachment and UE request PDN connectivity are carried out (step 1) between a radio base station (eNB), a relay node UE positioned within the coverage of the radio base station (ProSe UE-to-NW Relay), an MME (Mobility Management Entity), an SGW (Signaling Gateway), and a PGW (Packet Data Network Gateway).

A discovery process is performed between a communication terminal and a remote UE, and discovers a terminal with which D2D communication is possible (step 2). Such a discovery process is a model defined in Rel.12, in which model A is disclosed, which discovers a terminal via announcing and monitoring. Furthermore, there also is model B, not supported in Rel. 12, which discovers a terminal via a request and a response.

Next, if the remote UE discovers one or more communication terminals (ProSe UE-to-NW relays) via the discovery process, a communication terminal selection process is performed to decide which of the communication terminals to use as a relay device (step 3). At this stage, the remote UE may select a related PD connection.

Thereafter, a remote UE IP destination process is carried out between the remote UE and the communication terminal. At this stage, a router request is carried out from the remote UE addressed to the communication terminal (step 4), and a router advertisement addressed to the remote UE is sent from the communication terminal in accordance with the router request (step 5).

After the above processes are performed, a relay process using D2D is implemented. A signal which transmits a DL reception can be an independent signal (separate signal) or may be combined with other signals transmitted from the communication terminal (relay device) to the remote UE. For example, a group ID that is a 24 bit ID for DL reception may be included in a discovery message in the discovery process of step 2 in FIG. 12. In other words, in model A, the group destination L2 ID may be configured to be included in the discovery message as a 24 bit group ID, and to notify the remote UE thereof.

Furthermore, the signal that transmits the DL reception L2 ID can be designed as an independent signal that can use a D2D discovery channel or a communication channel. Furthermore, as illustrated in FIG. 12, the group destination L2 ID (DL reception layer 2 ID) may be transmitted from the communication terminal to the remote UE after a remote UE IP destination process is performed. The signaling overlapping may be reduced by generating in a group ID in accordance with predetermined rules based on the relay UE destination (e.g., an IP destination or an L2 destination, etc.).

The above-described notification method of the L2 group destination ID can be said to be a “method of explicitly notifying the L2 group destination ID”. However, other than the explicit notification method, a method which automatically configures an L2 group destination ID using part of the discovery message or an IP address is also conceivable.

(Aspect 3)

Aspect 3 will be hereinafter described with reference to FIGS. 7C, 13 and 14.

As described above, in aspect 3, the LSB 8 bits of the L2 destination ID are set the same for each remote UE, as illustrated in FIG. 7C. Each remote UE that utilizes the communication terminal UE1 as a relay device uses the same last 8 bits (LSB 8 bits) of the L2 destination ID. However, the MSB 16 bits (the remaining bits of the 24 bits of the L2 destination ID with the LSB 8 bits removed therefrom) of the L2 destination ID are different for each remote UE.

In aspect 3, although filtering at the remote UE is carried out at L2 and at L3, the L1 ID uses part of the L2 ID. Accordingly, aspect 3 is based on the concept of part of the L2 ID being commonly used in the remote UEs, and the remainder thereof being used in a remote UE-specific basis.

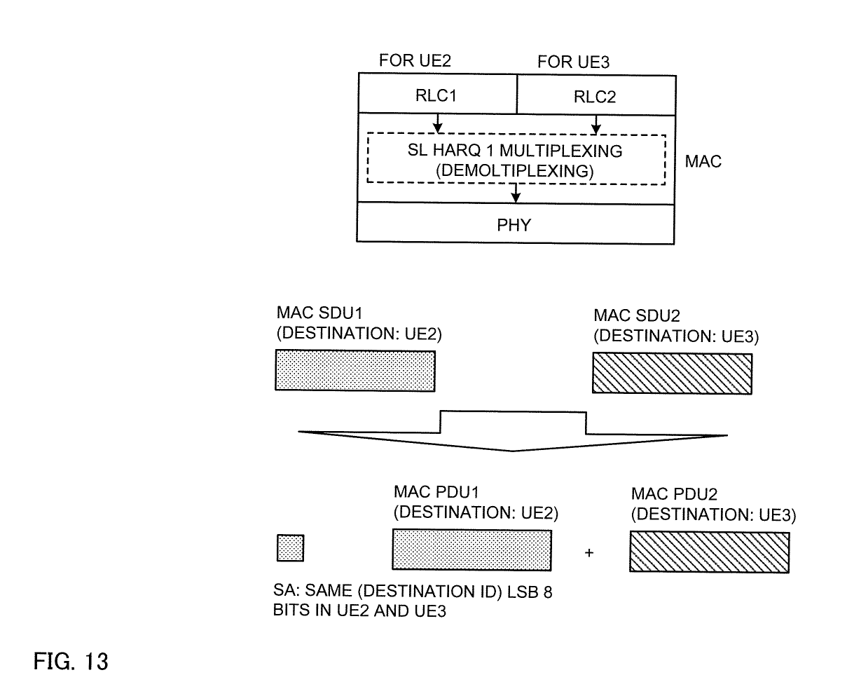

As illustrated in FIG. 13, a SL HARQ is configured in the MAC layer of the communication terminal UE1. This SL HARQ multiplexes (demultiplexes) data for different remote UEs. Specifically, SL HARQ1 adds a MAC header to an RLC PDU (MAC SDU1) addressed to the remote UE2 and generates a MAC PDU1. Furthermore, SL HARQ1 adds a MAC header to an RLC PDU (MAC SDU2) addressed to the remote UE3 and generates a MAC PDU2. The communication terminal UE1 generates a group ID that identifies the remote UE2/UE3.

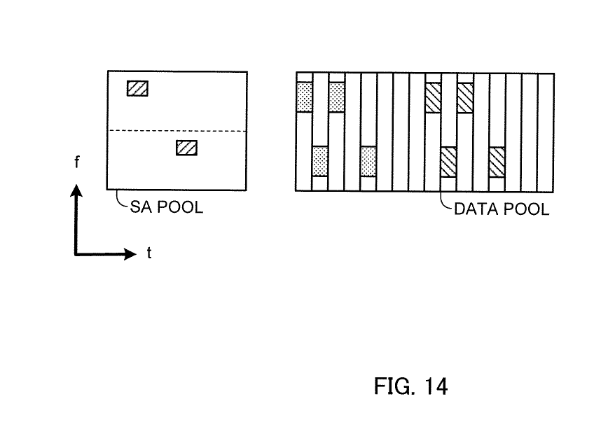

The communication terminal UE1 allocates the generated group ID to the PSCCH resource pool (FIG. 14). In the PSCCH resource pool illustrated in FIG. 14, frequency hopping is carried out. Furthermore, the communication terminal UE1 allocates the generated MAC PDU1 and MAC PDU2 to the PSSCH resource pool. For example, as illustrated in FIG. 14, resources of different subframes are respectively allocated to MAC PDU1 and MAC PDU2 so that MAC PDU1 and MAC PDU2 do not overlap each other along the time axis. Even in the case where frequency hopping is carried out, as illustrated in FIG. 14, resources of different subframes are respectively allocated to MAC PDU1 and MAC PDU2.

Due to the above-described resource allocation being carried out, data can be transmitted to a plurality of remote UEs in a single PSCCH period.

In the remote UE, the L2 destination ID, which is used to receive the DL data that is sent from the communication terminal UE (relay device), is notified by the communication terminal UE. Furthermore, in a single PSCCH period (SA period), a single PSCCH (SCI) indicates a resource that is allocated to a MAC PDU addressed to a plurality of remote UEs.

Note that since the communication processes for carrying out a relay process (DL reception of the remote UE) using D2D in aspect 3 are substantially the same as the steps discussed above in regard to aspect 2, a detailed description thereof is omitted herein.

In aspect 3, the signal for transmitting a DL reception L2 ID may be an independent signal (separate signal), or may be combined with other signals transmitted from the communication terminal (relay device) to the remote UE. In such a case, a D2D discovery channel or a D2D communication channel may be used. The common LSB 8 bits are set in the remote UEs in the same manner as in aspect 2, and the independent MSB 16 bits of the L2 destination ID may be generated in the remote UEs in accordance with predetermined rules based on each remote L2 ID; for example, a number of bits at the head or tail of the original L2 ID can be used for the predetermined rules. Furthermore, in the remote UE, the original L2 ID can be used for receiving other D2D data/signals.

In the embodiment of the present invention, explanations have been given based on the assumption that the remote UE is located within the coverage of the radio base station, however, the present invention is not limited thereto. The user terminal may be located within the coverage, or may designate another user terminal as a relay device for carrying out D2D to perform a process by which data transmitted from the radio base station is relayed. In particular, if a user terminal that is located outside the coverage moves within the coverage of the radio base station, such a user terminal may continue the D2D relay process.

In aspect 3, it is assumed that the MSB 16 bits of the L2 destination ID (the remaining bits upon the LSB 8 bits being removed from the L2 destination ID 24 bits) are different between different remote UEs; however, if the MSB 16 bits coincide with each other between different remote UEs, i.e., it would be effective to have a countermeasure for the case where the L2 destination IDs (MSB 16 bits) between a plurality of remote UEs conflict after the LSB 8 bits are rewritten (after being commonalized).

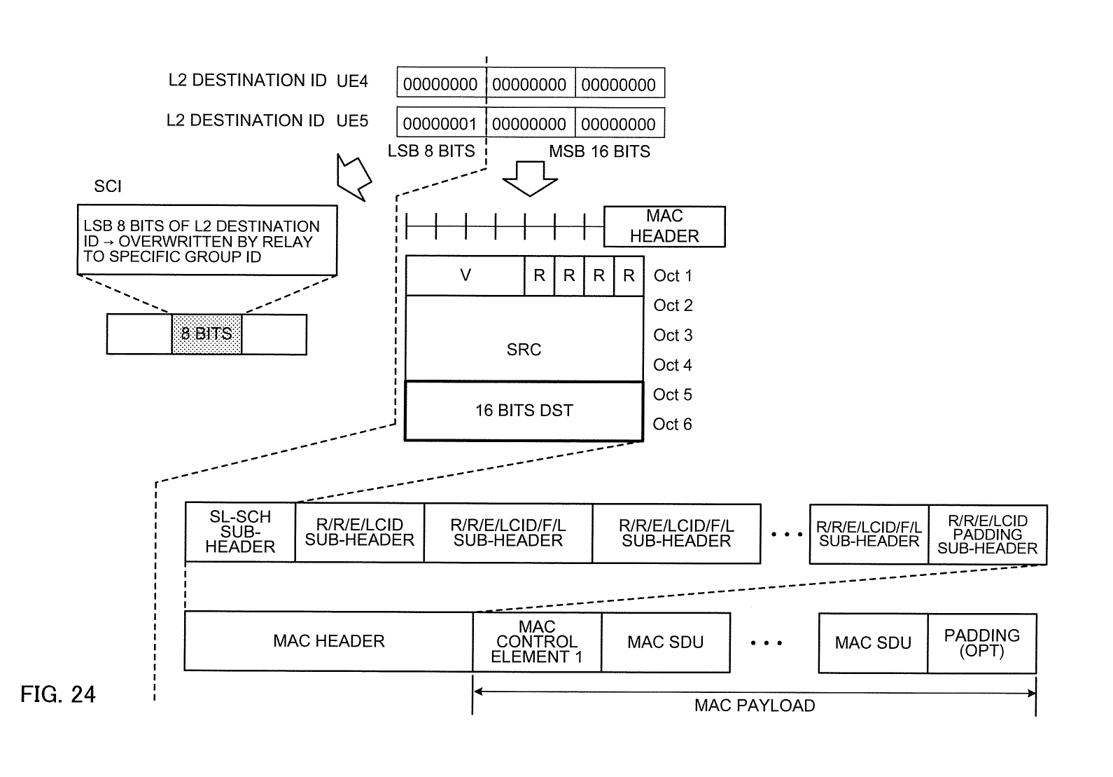

FIG. 24 is an explanatory diagram of such L2 destination IDs conflicting with each other. Note that in FIG. 24, for explanatory purposes, the LSB 8 bits are illustrated on the left side and the MSB 16 bits are illustrated on the right side. FIG. 24 illustrates L2 destination IDs for a remote UE2 and a remote UE3 that belong to the same group. In these L2 destination IDs, only one bit out of the LSB 8 bits is different. In the above-described aspect 3, when the LSB 8 bits are incorporated into the SCI, an intra-group common ID is rewritten (overwritten).

On the other hand, although the MSB 16 bits are incorporated into the MAC header, since the ID bit that was different between the remote UE2 and the remote UE3 is included in the LSB 8 bits, the MSB 16 bits incorporated into the MAC header become the same bit array for the remote UE2 and the remote UE3. Therefore, the remote UE2 and the remote UE3 are unable to determine whether or not the data they receive are addressed to themselves.

Furthermore, since it is conceivable for the relay UE or the radio base station not to distribute (offer) an L2 destination ID, it would be effective to have a countermeasure for the case where the L2 destination IDs (MSB 16 bits) between a plurality of remote UEs conflict. Although the above description is directed to the case where relaying is carried out between terminals, it would also be effective to similarly overwrite an SCI destination ID for transmitting data that is addressed to a plurality of terminals in the case where relaying is not utilized, and it would be possible to apply the countermeasure against conflict between the same L2 destination IDs.

(Aspect 3-1)

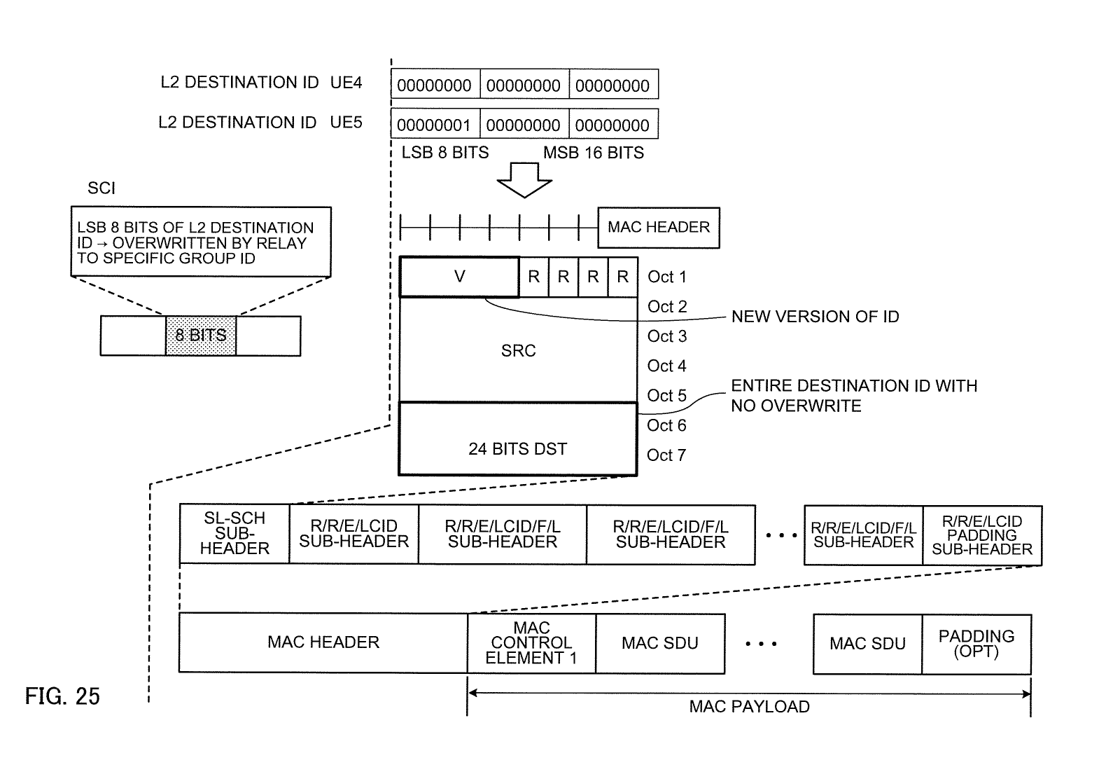

Aspect 3-1 will be herein discussed with reference to FIG. 25. Note that in FIG. 25, for explanatory purposes, the LSB 8 bits are illustrated on the left side and the MSB 16 bits are illustrated on the right side. In aspect 3-1, a countermeasure is taken for the case where L2 destination IDs (MSB 16 bits) conflict between a plurality of UEs. In aspect 3-1, as illustrated in FIG. 25, a new MAC header is defined. In this MAC header, the LSB 8 bits are included in the entire L2 destination ID (24 bits) before the LSB 8 bits are overwritten in the group ID. Accordingly, in the SCI, it is possible to distinguish the L2 destination IDs in terminals UE4 and UE5 that receive D2D communication, even if the LSB 8 bits are overwritten in the group ID.

In order to distinguish the new MAC header from the existing MAC header, it is necessary to define a version ID corresponding to the new MAC header. Furthermore, each of the UE4 and UE5 are configured to recognize that both the L2 destination ID before the LSB 8 bits are rewritten and the L2 destination ID after the LSB 8 bits are rewritten are its own L2 destination ID.

Higher layer signaling or physical layer signaling may be used for the radio base station to notify a transmission terminal whether to use an existing MAC header or a new MAC header, or the transmission terminal may autonomously perform the selection thereof. In the case where notification is carried out using higher layer signaling, the MAC header various may be notified, or a MAC header version applied for each RNTI may be defined.

Hence, according to aspect 3-1, even if the LSB 8 bits that are included in the SCI are rewritten in order to be the same for a plurality of UEs, each UE can distinguish the L2 destination IDs in the MAC header. Accordingly, in D2D, data can be efficiently transmitted to a plurality of UEs. Note that, as clearly understood in the above descriptions, aspect 3-1 can be applied to a D2D user terminal. Therefore, aspect 3-1 can also be similarly applied in the case where a relaying process is carried out between D2D user terminals. For example, the present aspect may be applied to the remote UE2 and the remote UE3 illustrated in FIG. 3.

(Aspect 3-2)

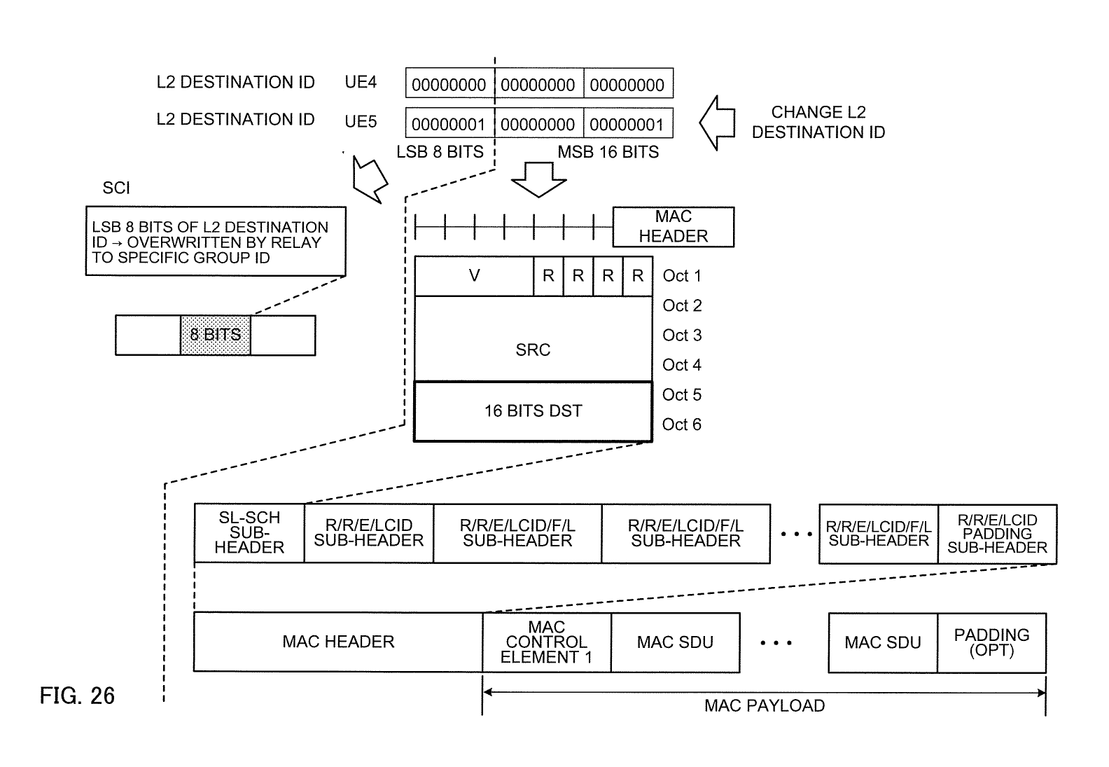

Next, aspect 3-2 will be herein discussed with reference to FIG. 26. Note that in FIG. 26, for explanatory purposes, the LSB 8 bits are illustrated on the left side and the MSB 16 bits are illustrated on the right side. In aspect 3-2, if conflict occurs between the L2 destination IDs, a UE autonomously changes the L2 destination ID thereof. For example, in the case where relaying is used in which communication has already been established with a relay UE, the remote UE restarts the IP address process (e.g., processes after step 3 in FIG. 12) between itself and the relay UE.

Furthermore, in the case where a remote UE is used in relaying and before the remote UE carries out a relaying process with a relay UE (establishes relay communication), the remote UE broadcasts its own L2 destination ID (MSB 16 bits). The UE that receives the L2 destination ID of the remote UE determines whether or not the broadcasted MSB 16 bits conflict with the MSB 16 bits of its own L2 destination ID; and if a conflict occurs, the UE notifies the remote UE accordingly. If the remote UE is notified by another UE that a conflict occurred, the remote UE changes the MSB 16 bits of its own L2 destination ID.

In FIG. 26, the UE5 has detected that the MSB 16 bits of its own L2 destination ID conflict with the MSB 16 bits of the UE4, and has changed the lowest bit of its own MSB 16 bits from “0” to “1”.

Note that it is desirable for the above-described UE process, or the UE process broadcast by the L2 destination ID, in aspect 3-2, to be defined as a UE operation. Furthermore, the notification of the L2 destination ID from the UE is not limited to the above-mentioned broadcast, a notification using a PSSCH and a PSCCH may be used, or a discovery signal (PSDCH) may be used.

Hence, according to aspect 3-2, even in the case where the LSB 8 bits included in the SCI are rewritten to become the same for a plurality of UEs, the MSB 16 bits of the L2 destination ID are appropriately changed. Accordingly, in D2D, data can be efficiently transmitted to a plurality of UEs. Furthermore, as can be clearly understood from the above explanations, aspect 3-2 can be applied to D2D user terminals (reception user terminals). Accordingly, if a relaying process is carried out between D2D user terminals, aspect 3-2 can similarly be applied to the remote terminal. For example, the present aspect may be applied to the remote UE2 and the remote UE3 illustrated in FIG. 3.

(Aspect 3-3)

Next, aspect 3-3 will be herein described. In aspect 3-3, an L2 destination ID conflict is detected in the transmitting UE, which differs from aspect 3-2. In the case where relaying is used, the relay UE detects an L2 destination ID conflict immediately before or immediately after a relaying process is carried out (establishment of relay communication). Normally, when any kind of request is transmitted from the remote UE to the relay UE, the remote UE reception L2 destination ID is included in the information that is transmitted. The relay UE detects a conflict using the transmitted L2 destination ID.

The transmitting UE determines whether or not the MSB 16 bits of the L2 destination ID included in the request conflicts with MSB 16 bits of another destination UE, and if a conflict occurs, the destination UE is notified accordingly. If the destination UE has been notified of a conflict from another UE, the destination UE changes the MSB 16 bits of its own L2 destination ID (FIG. 26).

Notification of conflict from the transmitting UE to the receiving UE may use higher layer signaling such as, e.g., MAC control signaling or RRC signaling, etc. Furthermore, it is desirable for the relay UE and remote UE processes in the above described aspect 3 to be specified as procedures.

Hence, according to aspect 3-3, even if the LSB 8 bits included in the SCI are rewritten to be the same for a plurality of UEs, the MSB 16 bits of the L2 destination ID can be appropriately changed. Accordingly, in D2D, data can be efficiently transmitted to the plurality of destination UEs. Furthermore, as can be clearly understood from the above explanations, aspect 3-3 can be applied to D2D user terminals (transmitting user terminals). Accordingly, if a relaying process is carried out between D2D user terminals, aspect 3-3 can similarly be applied to the relay terminal. For example, the present aspect may be applied to the communication terminal UE1 illustrated in FIG. 3.

In aspect 3, since data transmission to different L2 destinations is performed using a shared resource, the D2D resource allocation from the radio base station must also be the same. Accordingly, the same group index may be used between remote UEs, in the same Sidelink BSR (Buffer Status Report) that is broadcast to the radio base station, to broadcast the same BSR. Therefore, the same destination ID may be used between remote UEs to broadcast the D2D transmission destination, which is broadcast to the radio base station. For example, the same destination ID can be achieved by setting bit arrays, out of the L2 destination group address, that differ between remote UEs to zero. Alternatively, the relay group destination may be broadcast by different signaling to that of conventional signaling.

(Configuration of Radio Communication System)

The following is a description of the configuration of a radio communication system according to the embodiment of the present invention. In this radio communication system, the above-described radio communication method pertaining to the embodiment of the present invention is applied. Furthermore, the above-described aspects 1 through 3 may be applied separately, or applied in combination. However, if a plurality of aspects 1 through 3 are combined, it is necessary to share the information that indicates which aspect corresponds to the relaying process between the transmission terminal and the remote UE.

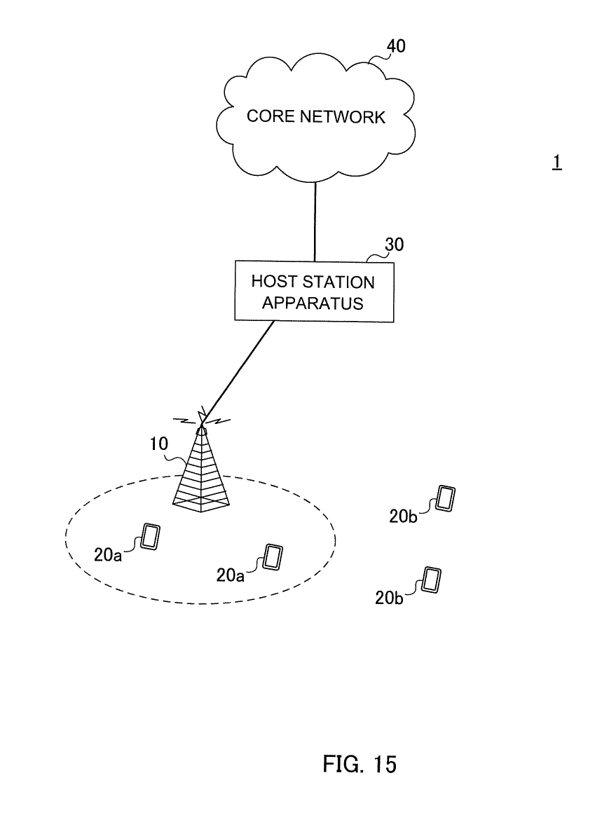

FIG. 15 is a schematic structure diagram illustrating an example of the radio communication system according to the present embodiment. The radio communication system illustrated in FIG. 15 is a system including, e.g., an LTE system, SUPER 3G, and an LTE-A system, etc. Carrier aggregation (CA) and/or dual connectivity (DC), which are an integrated group of a plurality of component carriers (PCC/SCC/TCC), can be applied to the radio communication system. Note that this radio communication system may be called “IMT-Advanced”, 4G, 5G or FRA (Future Radio Access).

The radio communication system 1 illustrated in FIG. 15 is provided with a radio base station 10 that forms a macrocell, and user terminals 20 (20a and 20b) located inside and outside the macrocell.

The user terminal 20a can be connected to the radio base station 10. The user terminal 20b is provided with the same configuration as that of the user terminal 20a, however, the user terminal 20b cannot directly connect to the radio base station 10 due to being located outside the coverage of the radio base station 10.

The radio base station 10 is connected to the host station apparatus 30, and is connected to the core network 40 via the host station apparatus 30. Note that the host station apparatus 30 includes, e.g., an access gateway device, radio network controller (RNC), and a mobility management entity (MME), etc., but is not limited thereto.

Note that the radio base station 10 is a radio base station having a relatively broad coverage, and may be called a macro base station, an aggregation node, an eNB (eNodeB), or a transmitting/receiving point, etc. A radio base station 12 is a radio base station having a local coverage, and may be called a small base station, a micro base station, a pico base station, a femto base station, an HeNB (Home eNodeB), an RRH (Remote Radio Head), or a transmitting/receiving point, etc. Each user terminal 20 is a user terminal that is compatible with the various types of communication schemes, such as LTE and LTE-A, etc., and the user terminals 20 also include fixed communication terminals in addition to mobile communication terminals.

In the radio communication system, as radio access schemes, OFDMA (Orthogonal Frequency Division Multiple Access) is applied to the downlink, and SC-FDMA (Single-Carrier Frequency Division Multiple Access) is applied to the uplink. OFDMA is a multi-carrier transmission scheme to perform communication by dividing a frequency band into a plurality of narrow frequency bands (subcarriers) and mapping data to each subcarrier. SC-FDMA is a single-carrier transmission scheme to reduce interference between terminals by dividing the system band into bands formed with one or continuous resource blocks, per terminal, and allowing a plurality of terminals to use mutually different bands. Note that the uplink and downlink radio access schemes are not limited to a combination of the above.

In the radio communication system 1, a downlink shared channel (PDSCH: Physical Downlink Shared Channel), which is shared by each user terminal 20a, a broadcast channel (PBCH: Physical Broadcast Channel), and a downlink L1/L2 control channel, etc., are used as downlink channels. User data, higher layer control information and predetermined SIBs (System Information Blocks) are communicated in the PDSCH. Furthermore, a MIB (Master Information Block) is communicated in the PBCH.

The downlink L1/L2 control channel includes a PDCCH (Physical Downlink Control Channel), an EPDCCH (Enhanced Physical Downlink Control Channel), a PCFICH (Physical Control Format Indicator Channel), and a PHICH (Physical Hybrid-ARQ Indicator Channel), etc. Downlink control information (DCI), etc., which includes PDSCH and PUSCH scheduling information, is transmitted by the PDCCH. The number of OFDM symbols used in the PDCCH is transmitted by the PCFICH. A HARQ delivery acknowledgement signal (ACK/NACK) for the PUSCH is transmitted by the PHICH. An EPDCCH that is frequency-division-multiplexed with a PDSCH (downlink shared data channel) can be used for transmitting the DCI in the same manner as the PDCCH.

Furthermore, the downlink reference signal includes a cell-specific reference signal (CRS), a channel state measurement reference signal (CSI-RS: channel state information-reference signal), and a user-specific reference signal utilized in demodulation (DM-RS: Demodulation Reference Signal), etc.

In the radio communication system 1, an uplink shared channel (PUSCH: Physical Uplink Shared Channel) that is shared by each user terminal 20, an uplink control channel (PUCCH: Physical Uplink Control Channel), and a random access channel (PRACH: Physical Random Access Channel), etc., are used as uplink channels. The PUSCH is used to transmit user data and higher layer control information. Furthermore, the PUCCH is used to transmit downlink radio quality information (CQI: Channel Quality Indicator), and delivery acknowledgement signals (HARQ-ACK), etc. A random access preamble (RA preamble) for establishing a connection with a cell is transmitted by the PRACH.

In the radio communication system 1, a PSSS (Primary Sidelink Synchronization Signal), an SSSS (Secondary Sidelink Synchronization Signal), a PSBCH (Physical Sidelink Broadcast Channel), a PSCCH (Physical Sidelink Control Channel) and a PSSCH (Physical Sidelink Shared Channel) are used as D2D supporting channels.

<Radio Base Station>

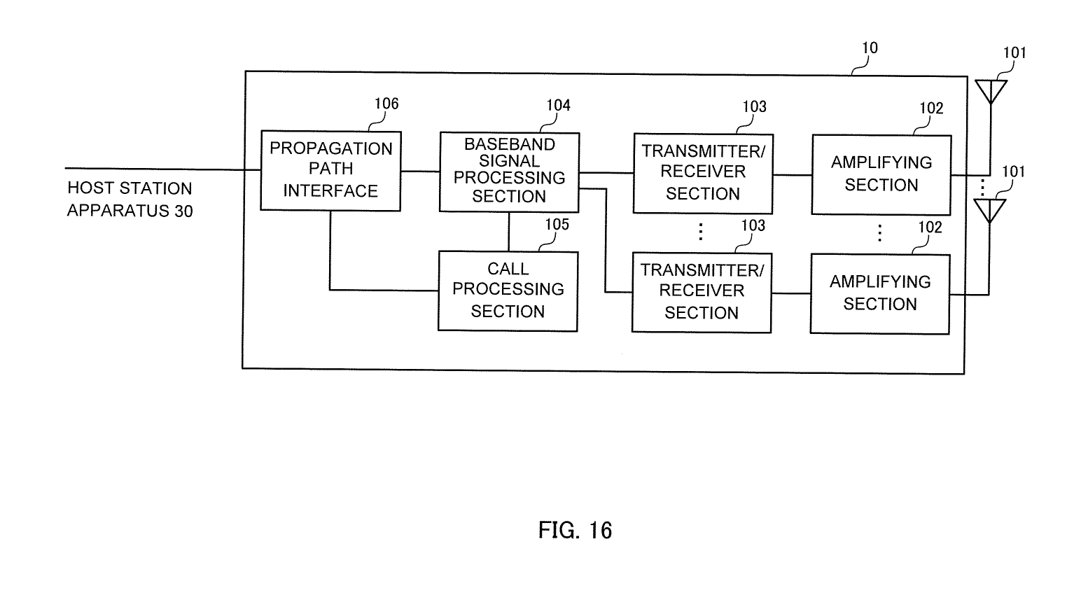

FIG. 16 is a diagram illustrating an overall structure of a radio base station 10 according to the embodiment of the present invention. The radio base station 10 is configured to have a plurality of transmission/reception antennas 101, amplifying sections 102, transmitting/receiving sections 103, a baseband signal processing section 104, a call processing section 105 and a propagation path interface 106. Furthermore, each transmitting/receiving section 103 is configured of a transmitting section and a receiving section.

User data that is to be transmitted on the downlink from the radio base station 10 to the user terminal 20a is input from the host station apparatus 30, via the propagation path interface 106, into the baseband signal processing section 104.

In the baseband signal processing section 104, in regard to the user data, signals are subjected to PDCP (Packet Data Convergence Protocol) layer processing, RLC (Radio Link Control) layer transmission processing such as division and coupling of user data and RLC retransmission control transmission processing, MAC (Medium Access Control) retransmission control (e.g., HARQ (Hybrid Automatic Repeat reQuest) transmission processing), scheduling, transport format selection, channel coding, inverse fast Fourier transform (IFFT) processing, and precoding processing, and resultant signals are transferred to the transmission/reception sections 103. Furthermore, also in regard to downlink control signals, transmission processing is performed, including channel coding and inverse fast Fourier transform, and resultant signals are transferred to the transmission/reception sections 103.

Each transmitting/receiving section 103 converts the baseband signals, output from the baseband signal processing section 104 after being precoded per each antenna, to a radio frequency band and transmits this radio frequency band. The radio frequency signals that are subject to frequency conversion by the transmitting/receiving sections 103 are amplified by the amplifying sections 102, and are transmitted from the transmission/reception antennas 101.

For example, each transmitting/receiving section 103 can transmit information relating to CCs that carry out CA (e.g., information on cells that become TCCs, etc.). Furthermore, the transmitting/receiving sections 103 can notify the user terminal of commands for a TCC reception operation and/or random access operation by utilizing PCC and/or SCC downlink control information (PDCCH/EPDCCH). Based on common recognition in the field of the art pertaining to the present invention, each transmitting/receiving section 103 can correspond to a transmitter/receiver, a transmitter/receiver circuit or a transmitter/receiver device.

Whereas, in regard to the uplink signals, radio frequency signals received by each transmission/reception antenna 101 are amplified by each amplifying section 102. The transmitting/receiving sections 103 receive the uplink signals that are amplified by the amplifying sections 102, respectively. The transmitting/receiving sections 103 frequency-convert the received signals into baseband signals and the converted signals are then output to the baseband signal processing section 104.

The baseband signal processing section 104 performs FFT (Fast Fourier Transform) processing, IDFT (Inverse Discrete Fourier Transform) processing, error correction decoding, MAC retransmission control reception processing, and RLC layer and PDCP layer reception processing on user data included in the input uplink signals. The signals are then transferred to the host station apparatus 30 via the propagation path interface 106. The call processing section 105 performs call processing such as setting up and releasing a communication channel, manages the state of the radio base station 10, and manages the radio resources.

The propagation path interface 106 performs transmission and reception of signals with the host station apparatus 30 via a predetermined interface. Furthermore, the propagation path interface 106 can perform transmission and reception of signals (backhaul signaling) with a neighboring radio base station 10 via an inter-base-station interface (for example, optical fiber, X2 interface).

<User Terminal>

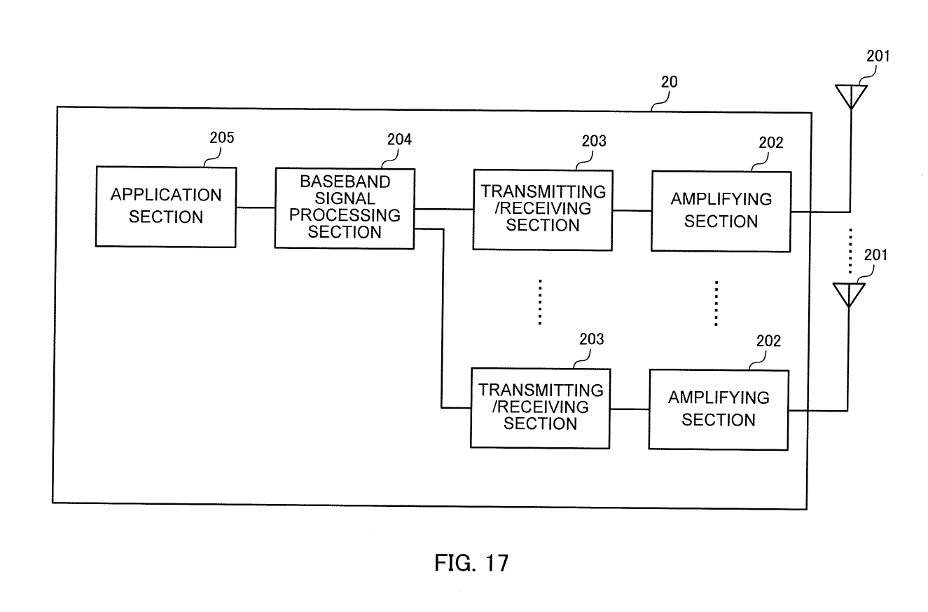

FIG. 17 is an illustrative diagram of an overall configuration of a user terminal according to the embodiment of the present invention. The user terminal 20 is provided with a plurality of transmitting/receiving antennas 201 for MIMO communication, amplifying sections 202, transmitting/receiving sections 203, a baseband signal processing section 204 and an application section 205. Note that each transmitting/receiving section 203 may be configured of a transmitting section and a receiving section.

Radio frequency signals that are received in the plurality of transmitting/receiving antennas 201 are respectively amplified in the amplifying sections 202. Each transmitting/receiving section 203 receives a downlink signal that has been amplified by an associated amplifying section 202. The transmitting/receiving sections 203 perform frequency conversion on the reception signals to convert into baseband signals, and are thereafter output to the baseband signal processing section 204.

Based on common recognition in the field of the art pertaining to the present invention, the transmitting/receiving section 203 can correspond to a transmitter/receiver, a transmitting/receiving circuit or a transmitting/receiving device.

The input baseband signal is subjected to an FFT process, error correction decoding, a retransmission control receiving process, etc., in the baseband signal processing section 204. The downlink user data is forwarded to the application section 205. The application section 205 performs processes related to higher layers above the physical layer and the MAC layer. Furthermore, out of the downlink data, broadcast information is also forwarded to the application section 205.

On the other hand, uplink user data is input to the baseband signal processing section 204 from the application section 205. In the baseband signal processing section 204, a retransmission control transmission process (e.g., a HARQ transmission process), channel coding, precoding, a discrete fourier transform (DFT) process, an inverse fast fourier transform (IFFT) process, etc., are performed, and the result is forwarded to each transmitting/receiving section 203. The baseband signal that is output from the baseband signal processing section 204 is converted into a radio frequency band in the transmitting/receiving sections 203. Thereafter, the amplifying sections 202 amplify the radio frequency signal having been subjected to frequency conversion, and transmit the resulting signal from the transmitting/receiving antennas 201.

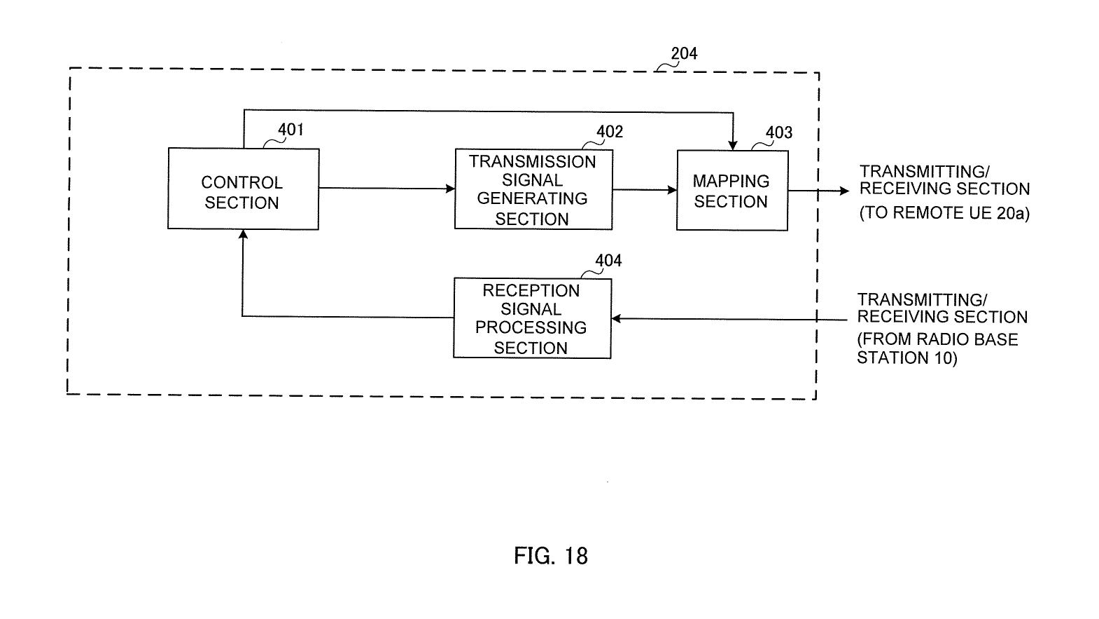

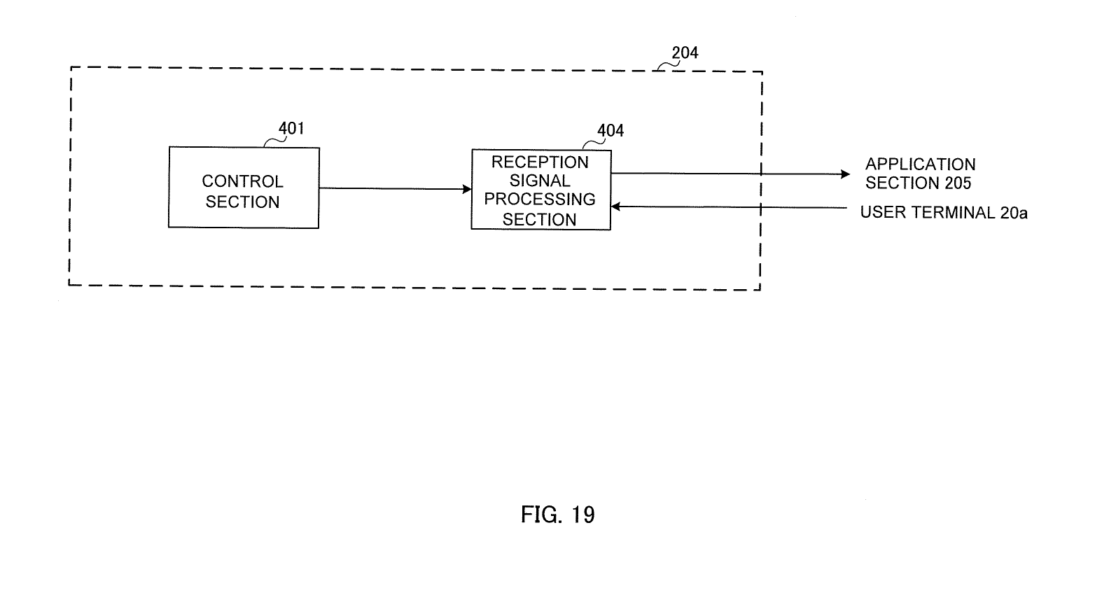

FIGS. 18 and 19 are diagrams illustrating the functional structure of the user terminal according to the present embodiment. FIG. 18 illustrates functions of the characteristic features of the user terminal 20 that functions as a relay device in D2D, and FIG. 19 illustrates functions of the characteristic features of the user terminal 20 in the case where UL data is received in the user terminal 20 from the relay device in D2D. However, although not illustrated in the drawings, the user terminal 20 is also provided with other functional blocks that are necessary for carrying out radio communication.

As illustrated in FIG. 18, the baseband signal processing section 204 provided in the user terminal 20 includes at least a control section 401, a transmission signal generating section 402, a mapping section 403, and a reception signal processing section 404.

In the case where the user terminal 20 itself functions as a relay device for D2D, the control section 401 controls the process of relaying data sent from the radio base station 10 to the remote terminal (a terminal located outside the coverage of the radio base station 10) using a UL resource in accordance with one of the above-described aspects 1 through 3. For example, the control section 401 controls the transmission signal generating section 402 and the mapping section 403 to perform a generating process for a destination ID and transmission data, as illustrated in FIGS. 8, 10 and 13.

The transmission signal generating section 402 generates a UL signal based on a command from the control section 401, and outputs the UL signal to the mapping section 403. For example, the transmission signal generating section 402 generates a MAC PDU for each remote terminal based on commands from the control section 401.

The mapping section 403 maps the uplink signals (destination ID(s) and/or uplink data), generated by the transmission signal generating section 402, to a radio resource based on commands from the control section 401, and outputs the result to the transmitting/receiving sections 203. Based on common recognition in the field of the art pertaining to the present invention, the mapping section 403 can correspond to a mapper, a mapping circuit or a mapping device.

The reception signal processing section 404 performs a receiving process (e.g., demapping, demodulating, or decoding, etc.) on the DL signal (e.g., a downlink control signal transmitted in a PDCCH/EPDCCH from the radio base station 10, or a downlink data signal transmitted in the PDSCH, etc.). The reception signal processing section 404 outputs the information received from the radio base station 10 to the control section 401. The reception signal processing section 404 outputs, e.g., broadcast information, system information, RRC signaling, and DCI, etc., to the control section 401.

As illustrated in FIG. 19, the baseband signal processing section 204, provided in the user terminal 20, is provided with the control section 401 and the reception signal processing section 404. When the control section 401, for example, receives data from a user terminal that functions as a relay device in D2D, the control section 401 determines whether or not the received data is addressed to itself. At this stage, in aspect 1, the destination ID sent via the PSCCH is used. In aspects 2 and 3, the group ID, the bits in the L2 destination ID other than the LSB, or the L3 destination ID is used.

If the control section's 401 own user terminal functions as a relay terminal, or if data is going to be transmitted to a plurality of destination IDs, or if requested from a user terminal, the control section 401 may configure a plurality of sidelink grants (aspects 1-1 through 1-3). Furthermore, generation and allocation of transmission data may be carried out based on a new MAC header (aspect 3-1), and a coinciding (conflict) of L2 destination IDs of a plurality of terminals can be detected, and if the L2 destination IDs do coincide, the user terminal may be notified accordingly (aspect 3-3).

If the control section's 401 own user terminal functions as a remote terminal, or if data is going to be transmitted to a plurality of destination IDs, or if requested from a user terminal, the control section 401 may configure a plurality of sidelink grants (aspects 1-1 through 1-3), and a receiving process of the data sent to itself may be performed based on a new MAC header (aspect 3-1). Furthermore, the control section 401 may determine whether or not the notified L2 destination ID is the same (conflict) as that of its own L2 destination ID, and if they are the same, may respond accordingly to the source terminal, from which the notification originated. Furthermore, if it is notified that the L2 destination IDs coincide (conflict) from the relay terminal or another terminal, the L2 destination ID may be changed (rewritten) (aspect 3-2, 3-3).

The reception signal processing section 404 performs a receiving process (e.g., demapping, demodulation, or decoding, etc.) on a signal (e.g., a control signal transmitted in the PSCCH from the user terminal, or a data signal transmitted in the PSSCH, etc.) received from a user terminal that functions as a relay device via a UL channel. The reception signal processing section 404 outputs the received information to the application section 205.

Based on common recognition in the field of the art pertaining to the present invention, the reception signal processing section 404 can correspond to a signal processor, a signal processing circuit, or a signal processing device. Furthermore, the reception signal processing section 404 can include the receiving section pertaining to the present invention.

Furthermore, the block diagrams used in the above description of the present embodiment indicate function-based blocks. These functional blocks (configured sections) are implemented via a combination of hardware and software. Furthermore, the implementation of each functional block is not limited to a particular means. In other words, each functional block may be implemented by a single device that is physically connected, or implemented by two or more separate devices connected by a fixed line or wirelessly connected.

For example, some or all of the functions of the radio base station 10 and the user terminal 20 may be implemented by using hardware such as ASICs (Application Specific Integrated Circuits), PLDs (Programmable Logic Devices) and FPGAs (Field Programmable Gate Arrays), etc. Furthermore, the radio base station 10 and the user terminal 20 may be each implemented by a computer device that includes a processor (CPU), a communication interface for connecting to a network, a memory and a computer-readable storage medium that stores a program(s).

The processor and memory, etc., are connected to buses for communication of information. Furthermore, the computer-readable storage medium includes, e.g., a flexible disk, a magnetic-optical disk, ROM, EPROM, CD-ROM, RAM, or a hard disk, etc. Furthermore, the program(s) may be transmitted from a network via electric telecommunication lines. Furthermore, the radio base station 10 and the user terminal 20 may also include an input device such as input keys, and an output device such as a display.

The functional configurations of the radio base station 10 and the user terminal 20 may be implemented using the above-mentioned hardware, may be implemented using software modules that are run by a processor, or may be implemented using a combination of both thereof. The processor controls the entire user terminal by operating an operating system. Furthermore, the processor reads a programs, software modules and data from the storage medium into a memory, and performs the various processes thereof accordingly. The above-mentioned program only needs to be a program that can perform the operations described in the above embodiment on a computer. For example, the control section 401 of the user terminal 20 may be stored in the memory, and implemented by the processor operating a control program, and the other above-mentioned functional blocks can also be implemented in the same manner.

Hereinabove, the present invention has been described in detail by use of the foregoing embodiments. However, it is apparent to those skilled in the art that the present invention should not be limited to the embodiment described in the specification. For example, the above-described embodiments can be used separately or as a combination thereof. The present invention can be implemented as an altered or modified embodiment without departing from the spirit and scope of the present invention, which are determined by the description of the scope of claims. Therefore, the description of the specification is intended for illustrative explanation only and does not impose any limited interpretation on the present invention.

The disclosures of Japanese Patent Application No. 2015-080463, filed on Apr. 9, 2015, and Japanese Patent Application No. 2015-099523, filed on May 14, 2015, are incorporated herein by reference in their entireties.

1. A communication terminal comprising:
a setting section configured to set destination information of a layer 2 so that identification information included in the destination information separately identifies a plurality of terminals with which D2D is carried out; and
an allocating section configured to allocate, in one scheduling interval, the identification information to a control channel in a different subframe per each of the plurality of terminals, and to allocate, in the one scheduling interval, transmission data respectively transmitted to the plurality of terminals to a data channel in a different subframe per each of the plurality of terminals.

2. The communication terminal according to claim 1, wherein the plurality of terminals are located outside a coverage of a radio base station that communicates with the communication terminal, and
wherein the control channel is a PSCCH (Physical Sidelink Control Channel), the data channel is a PSSCH (Physical Sidelink Shared Channel), and the one scheduling interval is equal to one PSCCH period.

3. The communication terminal according to claim 2, wherein the communication terminal relays the data transmitted from the radio base station to the plurality of terminals as the transmission data.

4. The communication terminal according to claim 1, wherein the setting section configures, in the one scheduling interval, a sidelink grant per each different identification information, and
wherein the allocating section allocates the transmission data to the data channel in accordance with the sidelink grant.

5. A communication terminal comprising:
a setting section configured to set group information, in regard to destination information of a layer 2, that is shared between a plurality of terminals with which D2D is carried out,
an allocating section configured to allocate the group information to the control channel, and to allocate, in one scheduling interval, transmission data respectively transmitted to the plurality of terminals to a data channel in a different subframe per each of the plurality of terminals.

6. The communication terminal according to claim 5, wherein the setting section sets the destination information so that information, of the destination information from which the group information is removed, identifies the plurality of terminals, respectively.

7. The communication terminal according to claim 5, wherein the plurality of terminals are located outside a coverage of a radio base station that communicates with the communication terminal, and
wherein the control channel is a PSCCH (Physical Sidelink Control Channel), the data channel is a PSSCH (Physical Sidelink Shared Channel), and the one scheduling period is equal to one PSCCH period.

8. The communication terminal according to claim 7, wherein the communication terminal relays the data transmitted from the radio base station to the plurality of terminals as the transmission data.

9. The communication terminal according to claim 5, wherein the allocation section allocates the transmission data, in which all of the bits in the destination information of the layer 2 are included in a header, to the data channel.

10. The communication terminal according to claim 6, wherein in the case where the information of the destination information from which the group information is removed is the same as that of another user terminal, the setting section changes the information of the destination information from which the group information is removed.

11. The communication terminal according to claim 2, wherein the setting section configures, in the one scheduling interval, a sidelink grant per each different identification information, and
wherein the allocating section allocates the transmission data to the data channel in accordance with the sidelink grant.

12. The communication terminal according to claim 3, wherein the setting section configures, in the one scheduling interval, a sidelink grant per each different identification information, and
wherein the allocating section allocates the transmission data to the data channel in accordance with the sidelink grant.

13. The communication terminal according to claim 6, wherein the plurality of terminals are located outside a coverage of a radio base station that communicates with the communication terminal, and
wherein the control channel is a PSCCH (Physical Sidelink Control Channel), the data channel is a PSSCH (Physical Sidelink Shared Channel), and the one scheduling period is equal to one PSCCH period.
